(19) United States
(12) Patent Application Publication
(10) Pub. No.: US 2024/0399772 A1
(43) Pub. Date: Dec. 5, 2024

(54) PRINTING DEVICE AND CUTTING DEVICE

(71) Applicant: MIMAKI ENGINEERING CO., LTD., Nagano (JP)

(72) Inventors: Akihiko Kobayashi, Nagano (JP); Yosuke Seki, Nagano (JP)

(73) Assignee: MIMAKI ENGINEERING CO., LTD., Nagano (JP)

(21) Appl. No.: 18/701,600

(22) PCT Filed: Oct. 11, 2022
(86) PCT No.: PCT/JP2022/037791

§ 371 Date: Apr. 15, 2024

(30) Foreign Application Priority Data
Oct. 19, 2021 (JP) 2021-171042
Oct. 19, 2021 (JP) 2021-171043

(51) Int. Cl. B41J 11/70; B26D 1/18; B26D 7/00; B41J 15/16

(52) U.S. Cl. CPC B41J 11/70; B26D 1/18; B41J 15/16; B26D 2007/005

(57) ABSTRACT

Provided is a printing device including a printing mechanism that performs printing on a long medium and a cutting mechanism that cuts the medium after printing in a width direction of the medium orthogonal to a transport direction of the medium, the printing device capable of performing printing on the medium by the printing mechanism and transporting the medium toward the cutting mechanism even during the cutting of the medium by the cutting mechanism. A printing device (1) includes a tension applying mechanism (10) having a tension bar (9) that comes into contact with a medium (2) after printing to apply tension to the medium (2). The tension bar (9) is disposed between a printing mechanism (3) and a cutting mechanism (7) in the transport direction of the medium (2).

### TECHNICAL FIELD

The present invention relates to a cutting device that cuts a long medium, and a printing device that performs printing on the long medium and cutting the medium after printing.

### BACKGROUND ART

Conventionally, an inkjet recording apparatus that performs printing on a long sheet-like medium (recording medium) is known (see e.g., Patent Literature 1). An inkjet recording apparatus described in Patent Literature 1 includes a transport roller and a pinch roller that transports a medium, a recording head that ejects ink onto the medium to perform printing, a carriage on which the recording head is mounted, a platen disposed at a position facing the recording head, a cutter that cuts the medium after printing in a direction orthogonal to a transport direction of the medium, and a slitter that cuts the medium after printing along the transport direction of the medium.

In the inkjet recording apparatus described in Patent Literature 1, the cutter is disposed on the downstream side of the platen in the transport direction of the medium, and the slitter is disposed on the downstream side of the cutter in the transport direction of the medium. The cutter includes a cutter unit having a cutter blade, and a carriage on which the cutter unit is mounted. The cutter unit includes an upper movable blade and a lower movable blade as the cutter blades. The slitter includes two slitter units each having a cutter blade. The slitter unit includes an upper movable blade and a lower movable blade as the cutter blades. The two slitter units are disposed at intervals in the width direction of the medium.

In the inkjet recording apparatus described in Patent Literature 1, a medium cut by a cutter and a slitter is separated into a recorded object and a cut piece. In this inkjet recording apparatus, a part of the medium disposed between the two slitter units in the width direction of the medium becomes a recorded object, and for example, the remaining part of the medium disposed on both sides of the recorded object in the width direction of the medium becomes a cut piece. The recorded object and the cut piece are discharged through a sheet discharge guide disposed on the downstream side of the slitter in the transport direction of the medium.

### CITATION LIST

### Patent Literature

Patent Literature 1: Japanese Unexamined Patent Publication No. 2020-163726

### SUMMARY OF INVENTION

### Technical Problems

In the inkjet recording apparatus described in Patent Literature 1, if printing of the medium by the recording head is performed and the medium is transported from the platen toward the cutter while the medium is being cut by the cutter, a part of the medium being cut by the cutter slacks, and the medium may not be appropriately cut in a direction orthogonal to the transport direction of the medium. Therefore, in the inkjet recording apparatus described in Patent Literature 1, it is difficult to perform printing on the medium during the cutting of the medium by the cutter and transport the medium toward the cutter.

Furthermore, in the inkjet recording apparatus described in Patent Literature 1, the medium cannot be transported toward the slitter while printing of the medium is being performed by the recording head. Therefore, in the inkjet recording apparatus described in Patent Literature 1, the medium cannot be cut by the slitter while printing of the medium is being performed by the recording head.

Therefore, a first object of the present invention is to provide a printing device including a printing mechanism for performing printing on a long medium and a cutting mechanism for cutting the medium after printing in a width direction of the medium orthogonal to a transport direction of the medium, in which printing of the medium is performed by the printing mechanism even during the cutting of the medium by the cutting mechanism and the medium is transported toward the cutting mechanism.

A second object of the present invention is to provide a printing device including a printing mechanism for performing printing on a long medium and a second cutting mechanism for cutting the medium after printing along a transport direction of the medium, in which cutting of the medium by the second cutting mechanism is performed even while the medium is being printed by the printing mechanism.

The inventor of the present application has developed a cutting device including a cutting mechanism for cutting a medium in a width direction of the medium, such as a cutter described in Patent Literature 1. Since the cutter described in Patent Literature 1 includes an upper movable blade and a lower movable blade overlapping in the up-down direction as the cutter blades, the configuration of the cutter becomes complicated. Therefore, in order to simplify the configuration of the cutting mechanism in the cutting device under development, the inventor of the present application is considering to provide a platen for cutting (cutting platen) having an opposing portion disposed facing the cutting mechanism to reduce the number of cutter blades included in the cutting mechanism. In this case, if the end portion in the width direction of the medium is floating from the opposing portion of the cutting platen when starting to cut the medium in the width direction of the medium, the carriage or the like on which the cutter blade is mounted interferes with the end portion in the width direction of the medium, and the medium may not be appropriately cut.

Therefore, a third object of the present invention is to provide a cutting device including a cutting mechanism for cutting a medium in a width direction of the medium, the cutting device capable of appropriately cutting the medium by the cutting mechanism even if an end portion in the width direction of the medium is floating from an opposing portion of a cutting platen when starting to cut the medium in the width direction of the medium.

The inventor of the present application has developed a cutting device including a second cutting mechanism for cutting a medium along a transport direction of the medium, such as a slitter described in Patent Literature 1. The inventor of the present application is considering to provide the cutting device with an accommodating portion in which a part of a medium corresponding to the recorded object described in Patent Literature 1 is accommodated. Furthermore, the inventor of the present application is also considering to provide the cutting device with a medium winding mechanism for winding the remaining part of the medium corresponding to the cut piece described in Patent Literature 1 without cutting in the width direction of the medium. That is, the inventor of the present application is considering to provide a medium winding mechanism for winding the remaining part of the long medium elongated in the transport direction of the medium.

It has been apparent through researches of the inventors of the present application that when a portion of the medium to be accommodated is defined as a first medium portion, and a portion of the medium to be wound by the medium winding mechanism is defined as a second medium portion, in this case, when the second medium portion wound by the medium winding mechanism and moved toward the medium winding mechanism is inclined toward the first medium portion side moving toward the accommodating portion, an end face of the first medium portion on the second medium portion side and an end face of the second medium portion on the first medium portion side are brought into contact with each other with an excessive contact pressure at a predetermined position in the transport direction of the medium, and wrinkles may form in the first medium portion, or a jam in which the medium is jammed may occur inside the cutting device.

Therefore, a fourth object of the present invention is to provide a cutting device including a second cutting mechanism for cutting a medium along a transport direction of the medium, and in which the medium cut by the second cutting mechanism is separated into a first medium portion and a second medium portion, in which even if the second medium portion wound by the medium winding mechanism and moved toward the medium winding mechanism is inclined toward the first medium portion side moving toward the accommodating portion, an end face of the first medium portion on the second medium portion side and an end face of the second medium portion on the first medium portion side can be prevented from coming into contact with each other with an excessive contact pressure.

### Solutions to Problems

In order to solve the first problem described above, a printing device of the present invention includes a printing mechanism that performs printing on a long medium; a medium transporting mechanism that transports the medium in a longitudinal direction of the medium; a cutting mechanism that cuts the medium after printing in a width direction of the medium orthogonal to a transport direction of the medium; and a tension applying mechanism that includes a tension bar that comes into contact with the medium after printing and applies tension to the medium; in which the medium transporting mechanism is disposed on an upstream side of the tension bar in a transport direction of the medium, and the tension bar is disposed between the printing mechanism and the cutting mechanism in the transport direction of the medium.

The printing device of the present invention includes a tension applying mechanism having a tension bar that comes into contact with the medium after printing to apply tension to the medium, and the tension bar is disposed between the printing mechanism and the cutting mechanism in the transport direction of the medium. Therefore, in the present invention, even if printing is performed on the medium by the printing mechanism during the cutting of the medium by the cutting mechanism and the medium is transported toward the cutting mechanism by the medium transporting mechanism, the tension of the portion of the medium where the cutting by the cutting mechanism is performed can be maintained by the tension bar, and as a result, the medium can be appropriately cut by the cutting mechanism.

Therefore, in the present invention, printing of the medium by the printing mechanism can be performed even during the cutting of the medium by the cutting mechanism and the medium can be transported toward the cutting mechanism. Furthermore, in the present invention, since the variation in the tension of the medium when cutting is performed by the cutting mechanism can be suppressed by the tension bar, the state of the medium at the time of cutting by the cutting mechanism can be stabilized.

In the present invention, for example, the printing device includes a second medium transporting mechanism that transports the medium in a longitudinal direction of the medium, and a second cutting mechanism that cuts the medium after printing along a transport direction of the medium; in which
the second medium transporting mechanism and the second cutting mechanism are disposed on a downstream side of the tension bar in a transport direction of the medium. In this case, even in a state where the printing of the medium by the printing mechanism is being performed and the portion of the medium where the printing by the printing mechanism is being performed is stopped, the portion of the medium where the cutting by the second cutting mechanism is performed can be transported to the downstream side in the transport direction of the medium by the second medium transporting mechanism by the movement of the tension bar, and the cutting of the medium can be performed by the second cutting mechanism.

In order to solve the second problem described above, a printing device including a printing mechanism that performs printing on a long medium; a medium transporting mechanism and a second medium transporting mechanism that transport the medium in a longitudinal direction of the medium; a second cutting mechanism that cuts the medium after printing along a transport direction of the medium; and a tension applying mechanism that includes a tension bar that comes into contact with the medium after printing and applies tension to the medium; in which
the medium transporting mechanism is disposed on an upstream side of the tension bar in a transport direction of the medium, the second medium transporting mechanism is disposed on a downstream side of the tension bar in the transport direction of the medium, and the tension bar is disposed between the printing mechanism and the second cutting mechanism in the transport direction of the medium.

The printing device of the present invention includes a tension applying mechanism having a tension bar that comes into contact with the medium after printing to apply tension to the medium, and the tension bar is disposed between the printing mechanism and the second cutting mechanism in the transport direction of the medium. Therefore, in the present invention, even in a state where the portion of the medium where the printing by the printing mechanism is performed is stopped while the medium is being printed by the printing mechanism, the portion of the medium where the cutting by the second cutting mechanism is performed can be transported to the downstream side in the transport direction of the medium by the second medium transporting mechanism by the movement of the tension bar, and the cutting of the medium can be performed by the second cutting mechanism.

Therefore, in the present invention, the cutting of the medium can be performed by the second cutting mechanism even during the printing of the medium by the printing mechanism. Furthermore, in the present invention, since the variation in the tension of the medium when cutting is performed by the second cutting mechanism can be suppressed by the tension bar, the state of the medium at the time of cutting by the second cutting mechanism can be stabilized.

In the present invention, for example, the tension applying mechanism includes a biasing member that biases the tension bar in a direction of pressing the tension bar against the medium, and a bar holding portion that movably holds the tension bar; and the tension bar is movable with respect to the bar holding portion to a biasing direction side and a side opposite to the biasing direction side of the tension bar by the biasing member.

In the present invention, the printing device includes, for example, a heater for heating the medium after printing, and the heater is disposed between the printing mechanism and the tension bar in the transport direction of the medium. In this case, for example, the distance between the printing mechanism and the cutting mechanism in the transport direction of the medium becomes long, but in the present invention, even if the distance between the printing mechanism and the cutting mechanism in the transport direction of the medium becomes long, the printing of the medium by the printing mechanism can be performed during the cutting of the medium by the cutting mechanism and the medium can be transported toward the cutting mechanism. Furthermore, in this case, for example, the distance between the printing mechanism and the second cutting mechanism in the transport direction of the medium becomes long, but in the present invention, even if the distance between the printing mechanism and the second cutting mechanism in the transport direction of the medium becomes long, the cutting of the medium by the second cutting mechanism can be performed while the medium is being printed by the printing mechanism.

In the present invention, the printing mechanism includes, for example, an inkjet head that ejects ink onto the medium, a carriage on which the inkjet head is mounted, and a carriage driving mechanism that moves the carriage in a main scanning direction that is a width direction of the medium.

In the present invention, the tension applying mechanism preferably includes a first sensor for detecting the position of the tension bar on the biasing direction side and a second sensor for detecting the position of the tension bar on the side opposite to the biasing direction side. With this configuration, the variation in the tension of the medium when the cutting is performed by the cutting mechanism and the variation in the tension of the medium when the cutting is performed by the second cutting mechanism can be effectively suppressed by controlling the transportation amount of the medium based on the detection results of the first sensor and the second sensor.

In order to solve the third problem described above, a cutting device of the present invention relates to a cutting device for cutting a long medium, the cutting device including a medium transporting mechanism configured to transport the medium in a longitudinal direction of the medium, a cutting mechanism configured to cut the medium in a width direction of the medium orthogonal to a transport direction of the medium, and a cutting platen having an opposing portion disposed facing the cutting mechanism; in which the cutting mechanism includes a cutter blade that cuts the medium, a carriage that holds the cutter blade, a carriage driving mechanism that moves the carriage in a width direction of the medium, and a medium pressing member that presses the medium toward the opposing portion, the medium pressing member is attached to the carriage, the medium pressing member is formed with an opposing surface facing the opposing portion,
assuming that an advancing direction side of the carriage when the cutter blade cuts the medium is a first direction side, a first inclined surface is formed at an end portion on the first direction side of the opposing surface, the first inclined surface being inclined toward a side away from the opposing portion toward the first direction side, and the first inclined surface is disposed on the first direction side than the cutter blade.

In the cutting device of the present invention, the cutting mechanism includes a medium pressing member for pressing the medium toward the opposing portion of the cutting platen, and the medium pressing member is attached to the carriage. In the present invention, the medium pressing member is formed with an opposing surface facing the opposing portion. Furthermore, in the present invention, assuming that the advancing direction side of the carriage when the cutter blade cuts the medium is the first direction side, a first inclined surface is formed at an end portion on the first direction side of the opposing surface, the first inclined surface being inclined to a side away from the opposing portion toward the first direction side, and the first inclined surface is disposed on the first direction side than the cutter blade.

Therefore, in the present invention, even if the end portion in the width direction of the medium is floated from the opposing portion of the cutting platen (specifically, even if the end portion of the medium on the side opposite to the first direction side is floated) when the medium starts to be cut in the width direction of the medium, the medium can start to be cut with the cutter blade while pressing the end portion in the width direction of the medium floating from the opposing portion toward the opposing portion with the medium pressing member. Therefore, in the present invention, even if the end portion in the width direction of the medium is raised from the opposing portion of the cutting platen when starting to cut the medium in the width direction of the medium, the interference between the carriage and the end portion in the width direction of the medium can be prevented, and as a result, the medium can be appropriately cut by the cutting mechanism.

In the present invention, the cutting device includes, for example, a second cutting mechanism that cuts the medium along a transport direction of the medium, the second cutting mechanism is disposed on an upstream side of the cutting mechanism in the transport direction of the medium, and the cutting mechanism cuts a part of the medium so as to cross a portion of the medium cut by the second cutting mechanism, and cuts a part of the medium in a width direction of the medium.

In the present invention, assuming that a portion of the medium cut by the second cutting mechanism is a cut line, a portion of the medium disposed on one side in the width direction of the medium with the cut line as a boundary is a first medium portion, and a portion of the medium disposed on the other side in the width direction of the medium with the cut line as a boundary is a second medium portion, the cutting device includes, for example, an accommodating portion in which the first medium portion is accommodated, and a medium winding mechanism that winds the second medium portion. In the present invention, for example, the accommodating portion is disposed on the lower side of the cutting mechanism and the second cutting mechanism.

In this case, the end portion in the width direction of the first medium portion may be easily raised from the opposing portion of the cutting platen due to the influence of the contact of the first medium portion with the bottom surface of the accommodating portion and the influence of the weight of the first medium portion, but in the present invention, even if the end portion in the width direction of the first medium portion is raised from the opposing portion of the cutting platen when starting to cut the first medium portion in the width direction of the medium, the first medium portion can be started to be cut with the cutter blade while the end portion in the width direction of the first medium portion raised from the opposing portion is pressed toward the opposing portion by the medium pressing member, and hence interference between the carriage and the end portion in the width direction of the first medium portion can be prevented, and the first medium portion can be appropriately cut by the cutting mechanism.

In the present invention, the cutting device includes, for example, a printing mechanism that performs printing on a medium, and the printing mechanism is disposed on an upstream side of the second cutting mechanism in the transport direction of the medium.

In the present invention, the medium pressing member includes an inclined surface forming portion in which the first inclined surface is formed, and an end portion of the inclined surface forming portion on a downstream side in the transport direction of the medium is preferably a second inclined surface inclined toward an upstream side in the transport direction of the medium toward the first direction side. With this configuration, even when the medium is moved away from the opposing portion of the cutting platen toward the downstream side in the transport direction of the medium, the end portion in the width direction of the medium raised from the opposing portion and the end portion on the first direction side of the inclined surface forming portion can be prevented from coming into contact with each other, and the end portion in the width direction of the medium raised from the opposing portion can be pressed by the inclined surface forming portion.

In the present invention, assuming that the opposite side of the first direction side is the second direction side, for example, a third inclined surface is formed at an end portion on the second direction side of the opposing surface, the third inclined surface being inclined toward a side away from the opposing portion toward the second direction side.

In the present invention, for example, the cutter blade is a single-edged blade having a sharp edge. In this case, if the end portion in the width direction of the medium is raised from the opposing portion of the cutting platen when the cutter blade starts to cut the medium in the width direction of the medium, the portion other than the sharp portion of the cutter blade and the end portion in the width direction of the medium are likely to interfere with each other, and the medium may not be appropriately cut, but in the present invention, even if the end portion in the width direction of the medium is raised from the opposing portion of the cutting platen when the cutter blade starts to cut the medium in the width direction of the medium, the medium can be started to be cut with the cutter blade while the end portion in the width direction of the medium raised from the opposing portion is pressed toward the opposing portion by the medium pressing member, and thus the interference between the portion other than the sharp portion of the cutter blade and the end portion in the width direction of the medium can be prevented, and the medium can be appropriately cut with the cutting mechanism.

In order to solve the fourth problem described above, a cutting device of the present invention relates to a cutting device for cutting a long medium, the cutting device including a medium transporting mechanism that transports the medium in a longitudinal direction of the medium, and a second cutting mechanism that cuts the medium along a transport direction of the medium; and in which when a portion of the medium cut by the second cutting mechanism is defined as a cut line, a portion of the medium disposed on one side in a width direction of the medium orthogonal to a transport direction of the medium with the cut line as a boundary is defined as a first medium portion, and a portion of the medium disposed on the other side in the width direction of the medium with the cut line as a boundary is defined as a second medium portion, the cutting device includes an accommodating portion in which the first medium portion is accommodated; a medium winding mechanism that winds the second medium portion; and a guide member that is disposed between the accommodating portion and the second cutting mechanism in a transport direction of the medium and guides the first medium portion in a direction away from the second medium portion.

The cutting device of the present invention includes a guide member disposed between the accommodating portion and the second cutting mechanism in the transport direction of the medium, and the guide member guides the first medium portion in a direction away from the second medium portion. Therefore, in the present invention, even if the second medium portion wound by the medium winding mechanism and moving toward the medium winding mechanism is inclined toward the first medium portion moving toward the accommodating portion, the end face on the second medium portion side of the first medium portion guided in the direction away from the second medium portion by the guide member and the end face on the first medium portion side of the second medium portion can be prevented from coming into contact with each other with an excessive contact pressure.

In the present invention, the cutting device includes a cutting mechanism that cuts the medium in a width direction of the medium, in which the cutting mechanism is disposed between the second cutting mechanism and the guide member in the transport direction of the medium.

In the present invention, the cutting device includes a cutting platen having an opposing portion disposed facing the cutting mechanism, in which the cutting mechanism includes a cutter blade that cuts the medium, a carriage that holds the cutter blade, a carriage driving mechanism that moves the carriage in a width direction of the medium, and a medium pressing member that presses the medium toward the opposing portion, the medium pressing member is attached to the carriage, the medium pressing member is formed with an opposing surface facing the opposing portion, and assuming that an advancing direction side of the carriage when the cutter blade cuts the medium is a first direction side, a first inclined surface is formed at an end portion on the first direction side of the opposing surface, the first inclined surface being inclined to a side away from the opposing portion toward the first direction side, and the first inclined surface is disposed on the first direction side than the cutter blade.

In the present invention, since the first medium portion is guided in the direction away from the second medium portion by the guide member, when the first medium portion starts to be cut in the width direction of the medium, the end portion in the width direction of the first medium portion is raised from the opposing portion of the cutting platen, the carriage and the like and the end portion in the width direction of the first medium portion interfere with each other, and the first medium portion may not be appropriately cut, but with such a configuration, even if the end portion in the width direction of the first medium portion is raised from the opposing portion of the cutting platen when the first medium portion starts to be cut in the width direction of the medium, the first medium portion can start to be cut with the cutter blade while the end portion in the width direction of the first medium portion raised from the opposing portion is pressed by the medium pressing member toward the opposing portion. Therefore, even if the end portion in the width direction of the first medium portion is raised from the opposing portion when the first medium portion starts to be cut in the width direction of the medium, the interference between the carriage and the like and the end portion in the width direction of the first medium portion can be prevented, and as a result, the first medium portion can be appropriately cut by the cutting mechanism.

In the present invention, the cutting device includes, for example, a printing mechanism that performs printing on a medium, and the printing mechanism is disposed on an upstream side of the second cutting mechanism in the transport direction of the medium.

In the present invention, the cutting device includes, for example, a cutting platen having a second opposing portion disposed facing the second cutting mechanism, in which the guide member is attached to the cutting platen.

In this case, the guide member preferably includes a to-be-fixed member fixed to the cutting platen and a contact member that comes into contact with the first medium portion, in which the contact member is preferably attached to the to-be-fixed member, and an attachment position of the contact member with respect to the to-be-fixed member in a thickness direction of the medium is adjustable. With this configuration, the direction in which the guide member guides the first medium portion is adjustable. Therefore, in the present invention, even if the second medium portion wound by the medium winding mechanism and moving toward the medium winding mechanism is inclined to the first medium portion moving toward the accommodating portion, the end face on the second medium portion side of the first medium portion guided in the direction away from the second medium portion by the guide member and the end face on the first medium portion side of the second medium portion can be effectively prevented from coming into contact with each other with an excessive contact pressure.

In the present invention, the guide member may be attached to the accommodating portion or formed integrally with the accommodating portion.

### Effect of the Invention

As described above, in the present invention, in the printing device including the printing mechanism that performs printing on the long medium and the cutting mechanism that cuts the medium after printing in the width direction of the medium orthogonal to the transport direction of the medium, printing of the medium can be performed by the printing mechanism even during the cutting of the medium by the cutting mechanism and the medium can be transported toward the cutting mechanism. Furthermore, in the present invention, in the printing device including the printing mechanism that performs printing on the long medium and the second cutting mechanism that cuts the medium after printing along the transport direction of the medium, the medium can be cut by the second cutting mechanism even while the medium is being printed by the printing mechanism.

Furthermore, in the present invention, in the cutting device including the cutting mechanism for cutting the medium in the width direction of the medium, even if the end portion in the width direction of the medium is raised from the opposing portion of the cutting platen when the medium starts to be cut in the width direction of the medium, the medium can be appropriately cut by the cutting mechanism.

Moreover, in the present invention, in the cutting device including the second cutting mechanism for cutting the medium along the transport direction of the medium and in which the medium cut by the second cutting mechanism is separated into the first medium portion and the second medium portion, even if the second medium portion wound by the medium winding mechanism and moving toward the medium winding mechanism is inclined to the first medium portion moving toward the accommodating portion, the end face on the second medium portion side of the first medium portion and the end face on the first medium portion side of the second medium portion can be prevented from coming into contact with each other at an excessive contact pressure.

### BRIEF DESCRIPTION OF THE DRAWINGS

FIG. 1 is a side view for explaining a configuration of a printing and cutting device according to a first embodiment of the present invention.

FIG. 2 is a diagram for describing a printing example of a medium by a printing mechanism illustrated in FIG. 1 and a cutting example of the medium by a cutting mechanism and a second cutting mechanism.

FIG. 3 is an enlarged view of portion E in FIG. 1.

FIG. 4(A) is a perspective view of a part of the carriage, the medium pressing member, and the like of the cutting mechanism illustrated in FIG. 3, and FIG. 4(B) is a plan view of a distal end side portion of the cutter blade of the cutting mechanism illustrated in FIG. 3.

FIG. 5(A) is a front view of the medium pressing member shown in FIG. 4(A), and FIG. 5(B) is a plan view of the medium pressing member shown in FIG. 4(A).

FIG. 6 is a perspective view of a part of the supporting frame and the second cutting mechanism illustrated in FIG. 3.

FIG. 7 is a side view of a part of the supporting frame, a part of the cutting platen, the second cutting mechanism and the like illustrated in FIG. 3.

FIG. 8 is a view for explaining the action of the guide member illustrated in FIG. 3.

FIG. 9 is a side view of a first sensor and a second sensor for detecting the position of the tension bar illustrated in FIG. 3.

FIG. 10 is a block diagram for explaining a configuration of the printing and cutting device illustrated in FIG. 1.

FIG. 11 is a diagram for describing a printing method and a cutting method of a medium according to a second embodiment of the present invention.

FIG. 12 is a block diagram for explaining a configuration of a printing and cutting device according to the second embodiment of the present invention.

FIG. 13 is a side view for explaining a configuration of a guide member according to another embodiment of the present invention.

### DESCRIPTION OF EMBODIMENTS

Hereinafter, embodiments of the present invention will be described with reference to the drawings.

### First Embodiment

### (Overall Configuration of Printing and Cutting Device)

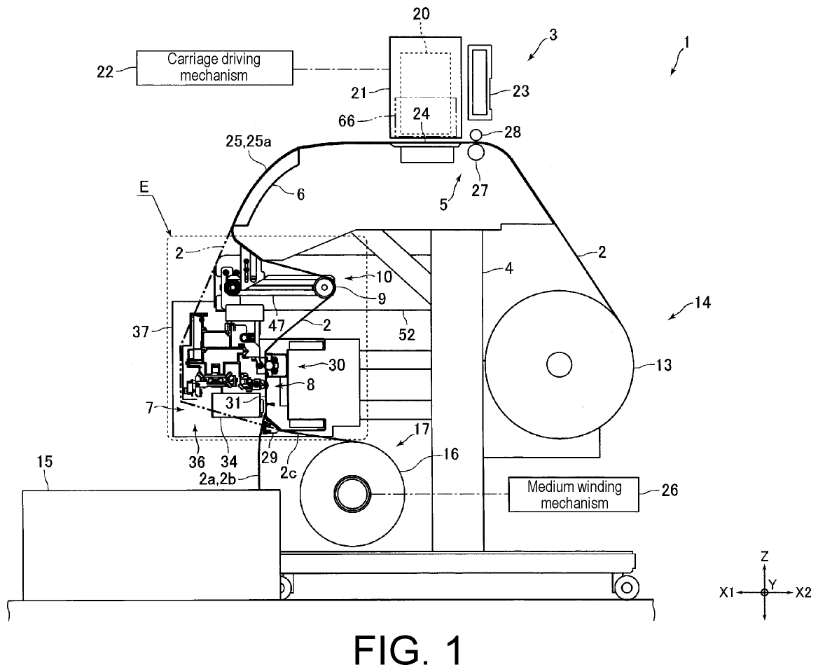

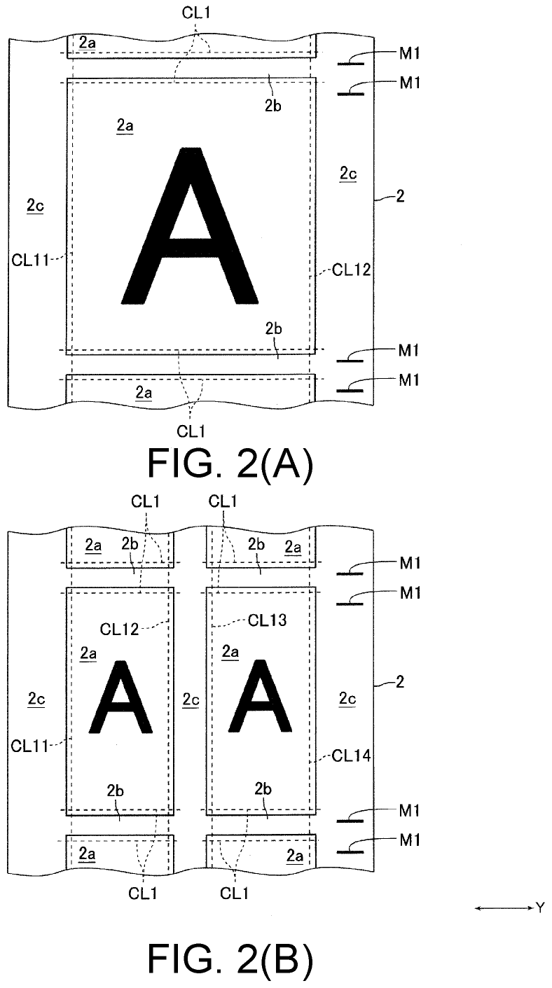

FIG. 1 is a side view for explaining a configuration of a printing and cutting device 1 according to a first embodiment of the present invention. The printing and cutting device 1 is a printing device and also a cutting device. FIG. 2 is a diagram for describing a printing example of a medium 2 by a printing mechanism 3 illustrated in FIG. 1 and a cutting example of the medium 2 by a cutting mechanism 7 and a second cutting mechanism 8.

The printing and cutting device 1 of the present embodiment is a commercial inkjet printer that performs printing on a long medium 2 and cuts the medium 2 after printing into a predetermined shape, and performs printing on the long medium 2 to be cut after printing. The medium 2 is, for example, a sheet-shaped medium made of a resin such as polyvinyl chloride or polyethylene terephthalate (PET). The medium 2 may be a sheet-like medium made of paper such as transfer paper or photographic paper. Furthermore, the medium 2 may be formed of tarpaulin or may be a window film.

The printing and cutting device 1 includes a printing mechanism 3 that performs printing on a long medium 2, a supporting body 4 that supports the printing mechanism 3 from the lower side, a medium transporting mechanism 5 that transports the medium 2, a heater (after heater) 6 that heats the medium 2 after printing, a cutting mechanism 7 that linearly cuts (slit processes) the medium 2 in a width direction of the medium 2 orthogonal to a transport direction of the medium 2, a second cutting mechanism 8 that linearly cuts (slit processes) the medium 2 along the transport direction of the medium 2, and a tension applying mechanism 10 having a tension bar 9 that comes into contact with the medium 2 and applies tension to the medium 2. The cutting mechanism 7 and the second cutting mechanism 8 cut the medium 2 after printing. The tension bar 9 comes into contact with the medium 2 after printing and applies tension to the medium 2.

The tension bar 9 is disposed between the printing mechanism 3 and the cutting mechanism 7 in the transport direction of the medium 2 (feeding direction of the medium 2). The heater 6 is disposed between the printing mechanism 3 and the tension bar 9 in the transport direction of the medium 2. The second cutting mechanism 8 is disposed between the tension bar 9 and the cutting mechanism 7 in the transport direction of the medium 2. That is, the tension bar 9 is disposed between the printing mechanism 3 and the second cutting mechanism 8 in the transport direction of the medium 2.

The printing and cutting device 1 cuts a rectangular or square to-be-cut portion 2a (see FIG. 2) including a printed portion of the medium 2 from the sheet-like medium 2 by the cutting mechanism 7 and the second cutting mechanism 8. For example, the printing and cutting device 1 cuts the to-be-cut portion 2a illustrated in FIG. 2(A) or the to-be-cut portion 2a illustrated in FIG. 2(B) from the medium 2. Assuming that a portion of the medium 2 cut by the cutting mechanism 7 is a cut line (discontinuity) CL1, and portions of the medium 2 cut by the second cutting mechanism 8 are cut lines CL11 to CL14, as illustrated in FIG. 2, the cut line CL1 parallel to the width direction of the medium 2 is formed on the medium 2 after being cut by the cutting mechanism 7, and the cut lines CL11 to CL14 along the transport direction of the medium 2 are formed on the medium 2 after being cut by the second cutting mechanism 8.

In the present embodiment, the cut lines CL11 and CL12 or the cut lines CL13 and CL14 are formed on both sides of the to-be-cut portion 2a in the width direction of the medium 2. In the example illustrated in FIG. 2(A), a portion surrounded by the two cut lines CL1 and the two cut lines CL11 and CL12 is the to-be-cut portion 2a, and in the example illustrated in FIG. 2(B), a portion surrounded by the two cut lines CL1 and the two cut lines CL11 and CL12 and a portion surrounded by the two cut lines CL1 and the two cut lines CL13 and CL14 is the to-be-cut portion 2a. The medium 2 is cut by the cutting mechanism 7 after being cut by the second cutting mechanism 8.

The cutting mechanism 7 cuts the medium 2 so as to cross the cut lines CL11 to CL14 (i.e., a portion of the medium 2 cut by the second cutting mechanism 8). That is, both ends of the cut line CL1 in the width direction of the medium 2 are disposed on the outer side than the two cut lines CL11 and CL12 or the two cut lines CL13 and CL14 in the width direction of the medium 2. Furthermore, the cutting mechanism 7 does not cut the medium 2 over the entire area in the width direction of the medium 2, but cuts a part of the medium 2 in the width direction of the medium 2. Furthermore, for example, as illustrated in FIG. 2(B), when two to-be-cut portions 2a are arranged side by side in the width direction of the medium 2, two cut lines CL1 respectively corresponding to the two to-be-cut portions 2a are formed at intervals in the width direction of the medium 2. In the present embodiment, there is a margin portion between the to-be-cut portions 2a in the transport direction of the medium 2. Furthermore, there are margin portions elongated in the transport direction of the medium 2 on both sides of the to-be-cut portion 2a in the width direction of the medium 2.

The printing and cutting device 1 includes a medium feeding unit 14 for holding a feeding roll 13 that is a medium 2 before printing wound in a roll shape. The printing and cutting device 1 includes an accommodating portion 15 in which a first margin portion 2b, which is a margin portion between the to-be-cut portions 2a in the transport direction of the medium 2, and the to-be-cut portion 2a are accommodated, and a medium winding unit 17 for holding the winding roll 16 in which the to-be-cut portion 2a and second margin portions 2c, which are margin portions on both sides of the first margin portion 2b, in the width direction of the medium 2 are wound in a roll shape. That is, the printing and cutting device 1 includes the medium feeding unit 14 to which the medium 2 wound in a roll shape before being transported toward the printing mechanism 3 is attached, and the medium winding unit 17 to which the medium 2 (more specifically, a part of the medium 2) wound in a roll shape after passing through the printing mechanism 3 is attached.

The printing mechanism 3 includes an inkjet head 20 (hereinafter, referred to as a “head 20”) that ejects ink onto the medium 2, a carriage 21 on which the head 20 is mounted, a carriage driving mechanism 22 that moves the carriage 21 in a main scanning direction (Y direction in FIG. 1 and the like) that is a width direction of the medium 2, a supporting frame 23 that supports the carriage 21 so as to be movable in the main scanning direction, and a print platen 24 disposed on the lower side of the carriage 21. The head 20 ejects ink downward. The carriage driving mechanism 22 includes, for example, a belt partially fixed to the carriage 21, a pulley around which the belt is stretched, and a motor for rotating the pulley. The medium 2 at the time of printing is placed on the print platen 24.

In the following description, a main scanning direction (width direction of medium 2, Y direction) is referred to as a “left-right direction”, and a direction orthogonal to the up-down direction (Z direction in FIG. 1 and the like) and the left-right direction is referred to as a “front-back direction”. Furthermore, an X1 direction side in FIG. 1 and the like, which is one side in the front-back direction, is referred to as a “front” side, and an X2 direction side in FIG. 1 and the like, which is the opposite side, is referred to as a “back” side. In the present embodiment, the medium 2 before printing is transported from the back side to the upper surface of the print platen 24, and the medium 2 after printing is transported from the upper surface of the print platen 24 to the front side.

Furthermore, in the present embodiment, the side on which the medium feeding unit 14 is disposed in the transport direction of the medium 2 is the upstream side in the transport direction of the medium 2, and the side on which the medium winding unit 17 is disposed in the transport direction of the medium 2 is the downstream side in the transport direction of the medium 2. In the following description, the transport direction of the medium 2 may be referred to as a “medium transport direction”, and the width direction of the medium 2 orthogonal to the transport direction of the medium 2 may be referred to as a “medium width direction”. Furthermore, in the following description, the upstream side in the transport direction of the medium 2 may be referred to as “upstream side in the transport direction”, and the downstream side in the transport direction of the medium 2 may be referred to as “downstream side in the transport direction”.

An after platen 25 is disposed on the front side of the print platen 24. A guide surface 25a for guiding the medium 2 transported from the print platen 24 toward the tension bar 9 is formed on the surface of the after platen 25. The guide surface 25a is formed in a convex curved surface shape. The medium 2 transported from the print platen 24 toward the tension bar 9 comes into contact with the guide surface 25a. The heater 6 is disposed inside the after platen 25 so as to lie along the guide surface 25a.

The medium transporting mechanism 5 transports the long medium 2 in the longitudinal direction of the medium 2. The medium transporting mechanism 5 includes a transport roller 27 and a pad roller 28 that is disposed facing the transport roller 27 and is biased toward the transport roller 27. The transport roller 27 and the pad roller 28 are disposed on the upstream side of the print platen 24 in the transport direction of the medium 2, and the medium transporting mechanism 5 is disposed on the upstream side of the tension bar 9 in the transport direction of the medium 2. The transport roller 27 is coupled to a driving mechanism for rotating the transport roller 27. The medium 2 is transported while being sandwiched between the transport roller 27 and the pad roller 28.

The tension applying mechanism 10 is disposed on the lower side of the after platen 25. The second cutting mechanism 8 is disposed on the lower side of the tension applying mechanism 10. The cutting mechanism 7 is disposed on the lower side of the second cutting mechanism 8. A specific configuration of the tension applying mechanism 10 will be described later. Furthermore, the configuration of the cutting mechanism 7, the configuration of the second cutting mechanism 8, and specific configurations of the peripheral portion of the cutting mechanism 7 and the second cutting mechanism 8 will be described later.

The medium feeding unit 14 is disposed on the lower side of the printing mechanism 3. The medium feeding unit 14 includes a rotating shaft inserted to the inner peripheral side of the feeding roll 13. The accommodating portion 15 is formed in, for example, a rectangular parallelepiped box shape whose upper surface is opened. The accommodating portion 15 is disposed on the lower side of the cutting mechanism 7 and the second cutting mechanism 8. Furthermore, the accommodating portion 15 is disposed on the lower side of the cutting mechanism 7.

The medium winding unit 17 is disposed on the lower side of the printing mechanism 3. The medium winding unit 17 is disposed on the lower side of the cutting mechanism 7. Furthermore, the medium winding unit 17 is disposed behind the cutting mechanism 7, the second cutting mechanism 8, and the accommodating portion 15. The medium winding unit 17 includes a medium winding mechanism 26 that winds the second margin portion 2c. The medium winding mechanism 26 includes a rotating shaft that is inserted into the inner peripheral side of the winding roll 16, a driving mechanism for rotating the rotating shaft, and a torque limiter for idling the winding roll 16 so that the tension of the second margin portion 2c wound around the winding roll 16 does not exceed a predetermined tension. An end portion on the downstream side in the transport direction of the medium 2 is fixed to the rotating shaft.

In the present embodiment, the portion of the medium 2 that becomes the to-be-cut portion 2a and the first margin portion 2b is a first medium portion that is a portion of the medium 2 disposed on one side in the width direction of the medium 2 with the cut lines CL11 to CL14 as boundaries, and the first medium portion is accommodated in the accommodating portion 15. The second margin portion 2c is a second medium portion that is a portion of the medium 2 disposed on the other side in the width direction of the medium 2 with the cut lines CL11 to CL14 as boundaries, and the medium winding mechanism 26 winds the second medium portion.

### (Configuration of Cutting Mechanism, Second Cutting Mechanism, and Peripheral Portion)

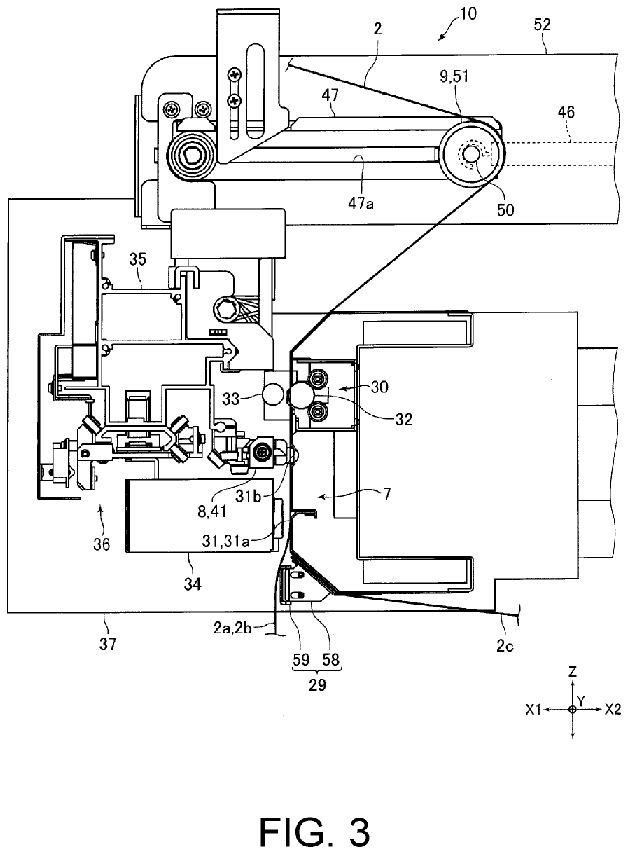

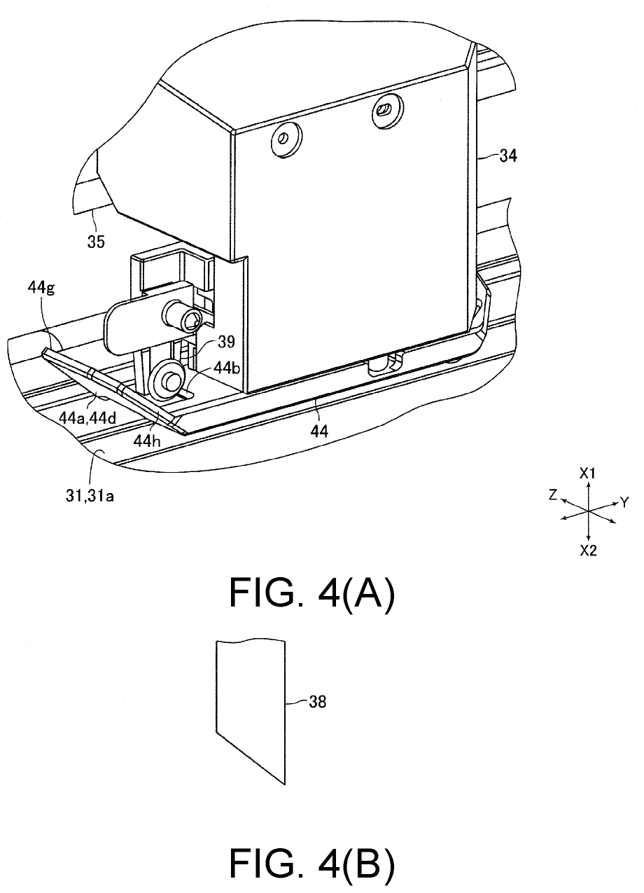

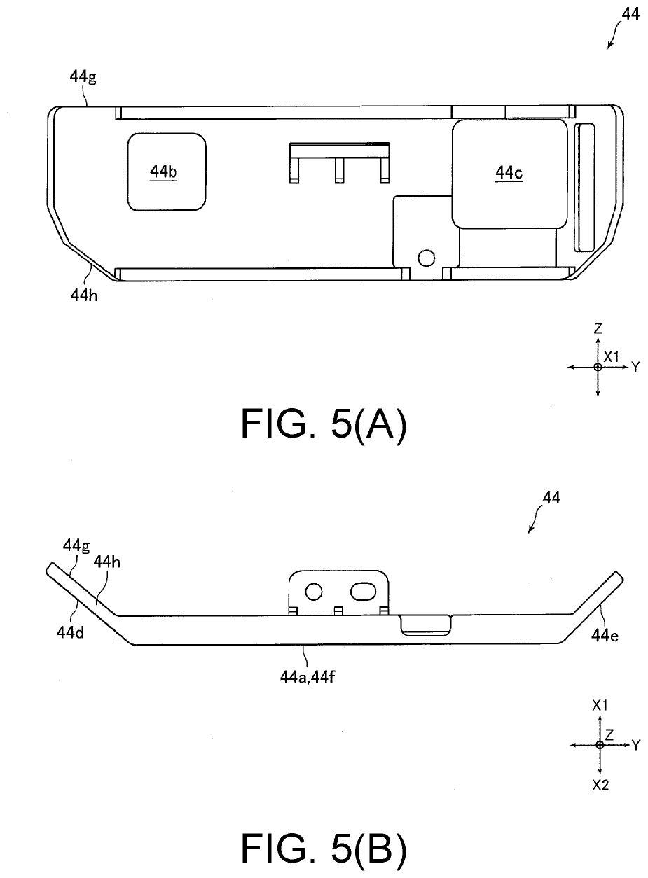

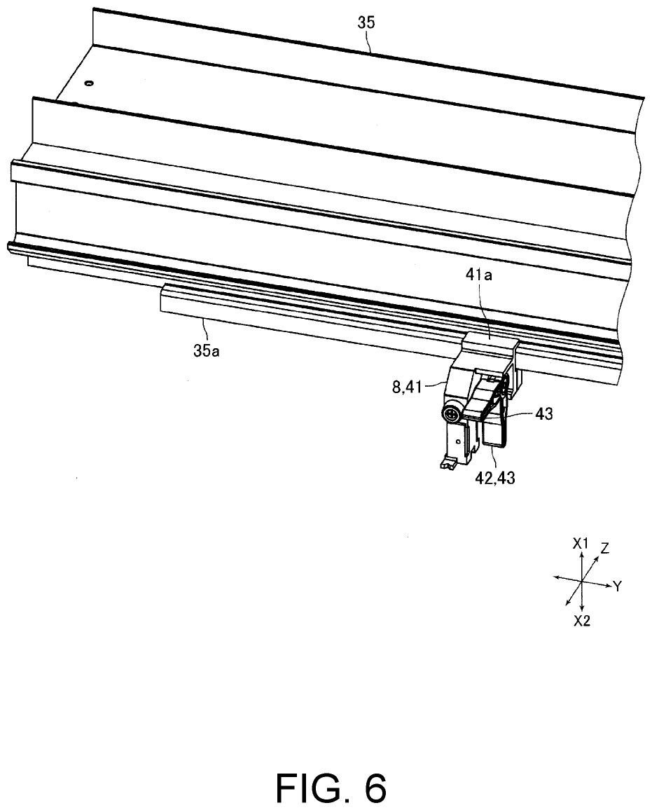

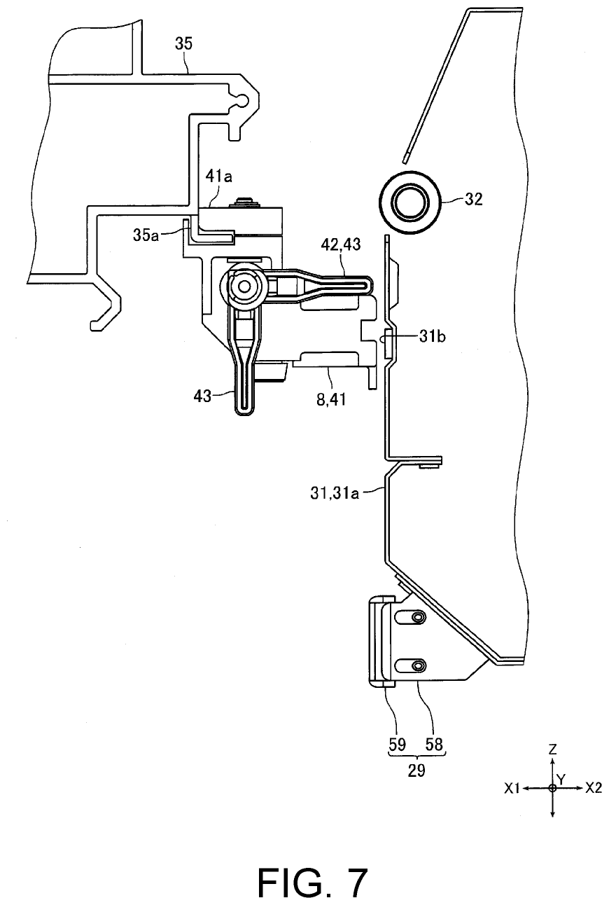

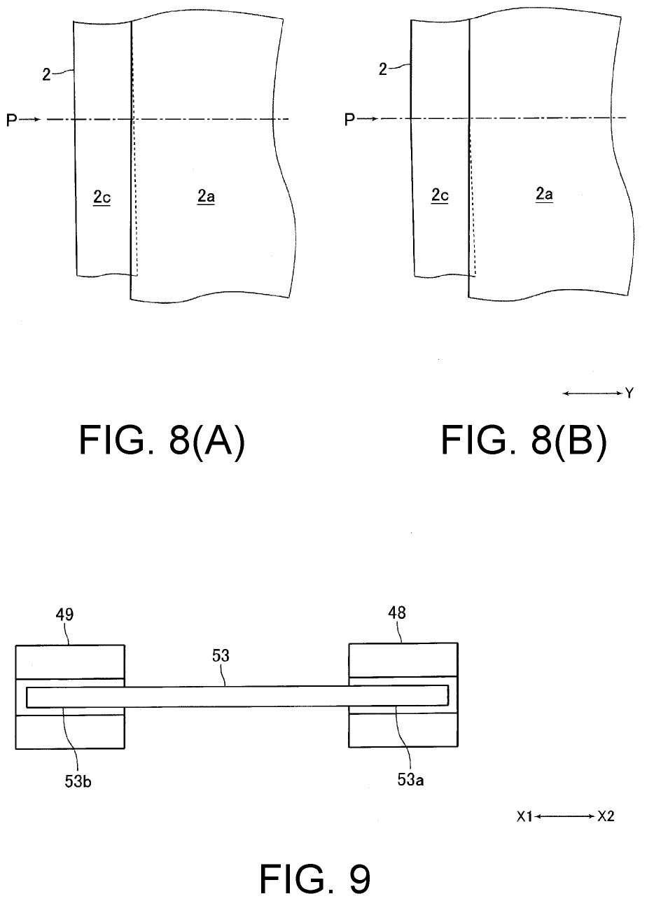

FIG. 3 is an enlarged view of portion E in FIG. 1. FIG. 4(A) is a perspective view of a part of the carriage 34, the medium pressing member 44, and the like of the cutting mechanism 7 illustrated in FIG. 3, and FIG. 4(B) is a plan view of a distal end side portion of the cutter blade 38 of the cutting mechanism 7 illustrated in FIG. 3. FIG. 5(A) is a front view of the medium pressing member 44 shown in FIG. 4(A), and FIG. 5(B) is a plan view of the medium pressing member 44 shown in FIG. 4(A). FIG. 6 is a perspective view of a part of the supporting frame 35 and the second cutting mechanism 8 illustrated in FIG. 3. FIG. 7 is a side view of a part of the supporting frame 35, a part of the cutting platen 31, the second cutting mechanism 8 and the like illustrated in FIG. 3. FIG. 8 is a diagram for explaining the action of the guide member 29 illustrated in FIG. 3.

The cutting mechanism 7 is disposed on the downstream side of the second cutting mechanism 8 in the transport direction of the medium 2. In other words, the second cutting mechanism 8 is disposed on the upstream side of the cutting mechanism 7 in the transport direction of the medium 2. Furthermore, the second cutting mechanism 8 is disposed on the downstream side of the tension bar 9 in the transport direction of the medium 2. The printing mechanism 3 is disposed on the upstream side of the cutting mechanism 7 and the second cutting mechanism 8 in the transport direction of the medium 2. As described above, the cutting mechanism 7 is disposed on the lower side of the second cutting mechanism 8. The cutting platen 31 serving as a cutting platen is disposed behind the cutting mechanism 7 and the second cutting mechanism 8, and the cutting platen 31 faces the cutting mechanism 7 and the second cutting mechanism 8 from the back side. That is, the printing and cutting device 1 includes the cutting platen 31 facing the cutting mechanism 7 and the second cutting mechanism 8 from behind.

The cutting platen 31 includes an opposing portion 31a disposed facing the cutting mechanism 7 and a second opposing portion 31b disposed facing the second cutting mechanism 8. A guide member 29 that guides the to-be-cut portion 2a and the first margin portion 2b in a direction away from the second margin portion 2c is attached to the cutting platen 31. That is, the printing and cutting device 1 includes the guide member 29 that guides the to-be-cut portion 2a and the first margin portion 2b in a direction away from the second margin portion 2c. The guide member 29 is fixed to the front lower end portion of the cutting platen 31.

At the place where the cutting mechanism 7 and the second cutting mechanism 8 are installed, the medium 2 is transported to the lower side along the front surface of the cutting platen 31, and is passed between the second cutting mechanism 8 and the second opposing portion 31b and between the cutting mechanism 7 and the opposing portion 31a. The tension bar 9 is disposed on the downstream side of the print platen 24 and is disposed on the upstream side of the cutting platen 31 in the transport direction of the medium 2. Furthermore, the cutting mechanism 7 and the second cutting mechanism 8 are disposed on the downstream side of the tension bar 9 in the transport direction of the medium 2.

A second medium transporting mechanism 30 serving as a medium transporting mechanism that transports the long medium 2 in the longitudinal direction of the medium 2 is disposed between the tension bar 9 and the second cutting mechanism 8 in the transport direction of the medium 2. That is, the printing and cutting device 1 includes the second medium transporting mechanism 30 that transports the medium 2, and the second medium transporting mechanism 30 is disposed on the downstream side of the tension bar 9 in the transport direction of the medium 2. Specifically, the transport roller 32 and the pad roller 33 (see FIG. 3) constituting the second medium transporting mechanism 30 are disposed between the tension bar 9 and the second cutting mechanism 8 in the transport direction of the medium 2.

The transport roller 32 and the pad roller 33 are disposed on the upper side of the second cutting mechanism 8. The pad roller 33 is disposed facing the transport roller 32 from the front side and is biased toward the transport roller 32. The transport roller 32 is coupled to a driving mechanism for rotating the transport roller 32. The medium 2 is transported while being sandwiched between the transport roller 32 and the pad roller 33.

The cutting mechanism 7 includes a cutter blade 38 (see FIG. 4(B)) that cuts the medium 2, a cutter holder 39 to which the cutter blade 38 is fixed, a carriage 34 that holds the cutter holder 39 so that the cutter holder 39 can move in the front-back direction, and a holder driving mechanism such as a solenoid that moves the cutter holder 39 in the front-back direction with respect to the carriage 34. The cutter blade 38 is held by the carriage 34 via the cutter holder 39. As illustrated in FIG. 4(B), the cutter blade 38 is a single-edged blade having a sharp edge. In FIG. 4(A), the illustration of the cutter blade 38 is omitted.

Furthermore, the cutting mechanism 7 includes a supporting frame 35 that supports the carriage 34 so as to be movable in the left-right direction (width direction of the medium 2), and a carriage driving mechanism 36 that moves the carriage 34 in the left-right direction with respect to the supporting frame 35. The supporting frame 35 is a long frame elongated in the left-right direction. Both end portions in the left-right direction of the supporting frame 35 are fixed to the front end portion of the side plate 37. Aback end portion of the side plate 37 is fixed to the supporting body 4. The carriage driving mechanism 36 includes, for example, a belt partially fixed to the carriage 34, a pulley around which the belt is stretched, and a motor for rotating the pulley.

Furthermore, the cutting mechanism 7 also includes a medium pressing member 44 for pressing the medium 2 toward the opposing portion 31a of the cutting platen 31. The medium pressing member 44 is attached to the carriage 34. Specifically, the medium pressing member 44 is attached to the back surface of the carriage 34 and faces the opposing portion 31a from the front side. The back surface of the medium pressing member 44 is an opposing surface 44a facing the opposing portion 31a. That is, the medium pressing member 44 is formed with the opposing surface 44a facing the opposing portion 31a. The medium pressing member 44 is formed with a through hole 44b in which a part of the cutter blade 38 is disposed, and a through hole 44c for allowing light emitted from a light emitting unit of a sensor 56, to be described later, mounted on the carriage 34 and light directed toward a light receiving unit of the sensor 56 to pass therethrough. The through holes 44b and 44c penetrate the medium pressing member 44 in the front-back direction. In FIG. 3, illustration of the medium pressing member 44 is omitted.

Both end portions in the left-right direction of the opposing surface 44a are inclined surfaces 44d and 44e inclined to the front side toward the outer side in the left-right direction. That is, both end portions of the opposing surface 44a in the left-right direction are inclined surfaces 44d and 44e inclined to a side away from the opposing portion 31a toward the outer side in the left-right direction. The inclined surfaces 44d and 44e are formed in a planar shape. A portion of the opposing surface 44a between the inclined surface 44d and the inclined surface 44e is a planar medium pressing surface 44f orthogonal to the front-back direction. The medium pressing surface 44f is formed in a rectangular shape.

In this embodiment, the cutter blade 38 cuts the medium 2 when the carriage 34 moves to one side in the left-right direction (width direction of the medium 2). Assuming that an advancing direction side of the carriage 34 when the cutter blade 38 cuts the medium 2 is a first direction side, and an opposite side of the first direction side is a second direction side, the inclined surface 44d is formed at an end portion of the opposing surface 44a on the first direction side, and is inclined to a side away from the opposing portion 31a (i.e., to the front side) toward the first direction side. The inclined surface 44d is disposed on the first direction side with respect to the cutter blade 38. The inclined surface 44e is formed at an end portion on the second direction side of the opposing surface 44a, and is inclined to a side away from the opposing portion 31a (i.e., to the front side) toward the second direction side. In this embodiment, the inclined surface 44d is a first inclined surface, and the inclined surface 44e is a third inclined surface.

When viewed from the up-down direction, the inclination angle of the inclined surface 44d with respect to the left-right direction is smaller than the inclination angle of the inclined surface 44e with respect to the left-right direction. The inclination angle of the inclined surface 44d with respect to the left-right direction when viewed from the up-down direction is, for example, about 40°, and the inclination angle of the inclined surface 44e with respect to the left-right direction when viewed from the up-down direction is, for example, about 45°. When viewed from the up-down direction, the length of the inclined surface 44d is longer than the length of the inclined surface 44e.

The end portion of the medium pressing member 44 on the first direction side where the inclined surface 44d is formed is an inclined surface forming portion 44g. A lower end portion of the inclined surface forming portion 44g is an inclined surface 44h inclined toward the upper side toward the first direction side. That is, the end portion of the inclined surface forming portion 44g on the downstream side in the transport direction of the medium 2 is an inclined surface 44h inclined toward the upstream side in the transport direction of the medium 2 toward the first direction side. The inclined surface 44h of the present embodiment is a second inclined surface.

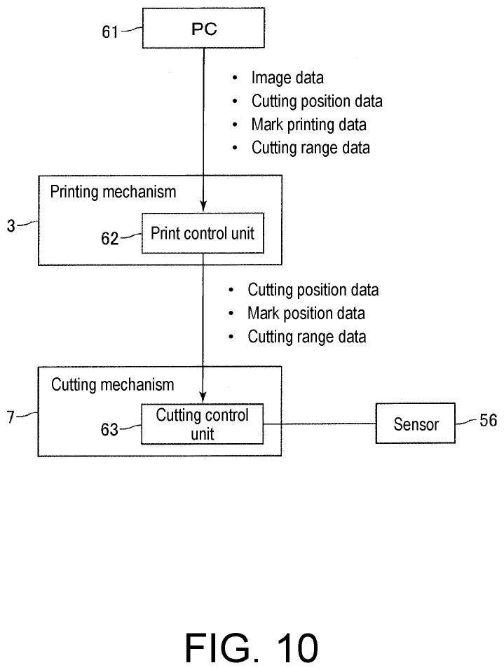

A sensor 56 (see FIG. 10) for detecting a cutting position mark M1 to be described later to be printed on the medium 2 is mounted on the carriage 34. That is, the printing and cutting device 1 includes a sensor (registration mark sensor) 56 for detecting the cutting position mark M1 to be printed on the medium 2. The sensor 56 is a reflective optical sensor, and includes a light emitting unit and a light receiving unit that receives light emitted from the light emitting unit and reflected by the medium 2. The light emitting unit of the sensor 56 emits light toward the back side. The sensor 56 is electrically connected to a cutting control unit 63 described later.

The second cutting mechanism 8 includes a cutter blade that cuts the medium 2. The cutter blade is, for example, a single-edged blade having a sharp edge. In addition, the second cutting mechanism 8 includes a cutter holder 41 attached to the supporting frame 35 so that the cutter blade is fixed and movable in the left-right direction, and a clamp mechanism 42 for fixing the cutter holder 41 with respect to the supporting frame 35. The fixing position of the cutter blade in the front-back direction with respect to the cutter holder 41 is manually adjustable.

The supporting frame 35 is formed with a guide portion 35a for guiding the cutter holder 41 in the left-right direction. The guide portion 35a is formed in a long shape elongated in the left-right direction. The shape of the guide portion 35a when viewed from the left-right direction is, for example, an L shape. The cutter holder 41 is formed with an engagement portion 41a that engages with the guide portion 35a. The engagement portion 41a can come into contact with the guide portion 35a from both sides in the front-back direction and from both sides in the up-down direction.

The clamp mechanism 42 is attached to the cutter holder 41. The clamp mechanism 42 is, for example, a clamp mechanism using an eccentric cam. The clamp mechanism 42 includes a lever 43 turnable with respect to the cutter holder 41 with the left-right direction as an axial direction of turning. The lever 43 is turnable between a clamping position at where the engagement portion 41a of the cutter holder 41 comes into contact with the guide portion 35a at a predetermined contact pressure, and an unclamping position at where a gap is formed between the engagement portion 41a and the guide portion 35a. In the present embodiment, the operator of the printing and cutting device 1 moves the cutter holder 41 to a predetermined position along the guide portion 35a while the lever 43 is at the unclamping position, and then turns the lever 43 to the clamping position to fix the cutter holder 41 to the supporting frame 35.

The length of the guide portion 35a in the left-right direction is shorter than the length of the supporting frame 35 in the left-right direction (see FIG. 6). A gap is formed between one end (e.g., left end) of the guide portion 35a in the left-right direction and the side plate 37. This gap is wider than the width of the second cutting mechanism 8 in the left-right direction. In the present embodiment, the second cutting mechanism 8 can be attached to the supporting frame 35 or the second cutting mechanism 8 can be detached from the supporting frame 35 using this gap. Specifically, the second cutting mechanism 8 can be attached to the supporting frame 35 by moving the second cutting mechanism 8 disposed in the gap to the right side to engage the engagement portion 41a with the guide portion 35a. Furthermore, the second cutting mechanism 8 can be detached from the supporting frame 35 by moving the second cutting mechanism 8 to the left side to the gap.

Therefore, in the present embodiment, the number of second cutting mechanisms 8 attached to the supporting frame 35 can be changed. For example, as illustrated in FIG. 2(A), when two cut lines CL11 and CL12 along the transport direction of the medium 2 are formed on the medium 2 by the second cutting mechanism 8, two second cutting mechanisms 8 are attached to predetermined positions of the supporting frame 35. For example, as illustrated in FIG. 2(B), when four cut lines CL11 to CL14 along the transport direction of the medium 2 are formed on the medium 2 by the second cutting mechanism 8, four second cutting mechanisms 8 are attached to predetermined positions of the supporting frame 35.

The driving mechanism for rotating the transport roller 32, the transport roller 32, and the cutting platen 31 are attached to the side plate 37. The pad roller 33 is attached to the supporting frame 35. As described above, the supporting frame 35 is fixed to the side plate 37, and the side plate 37 is fixed to the supporting body 4. The side plate 37 is fixed to the supporting body 4 with a screw. Therefore, in the present embodiment, a unit including the cutting mechanism 7, the second cutting mechanism 8, the second medium transporting mechanism 30, and the cutting platen 31 is attachable to and detachable from the supporting body 4. Furthermore, in the present embodiment, the cutting mechanism 7 and the second cutting mechanism 8 are fixed to the supporting body 4 via the side plate 37, and the printing mechanism 3, the cutting mechanism 7, and the second cutting mechanism 8 are attached to the same supporting body 4.

The guide member 29 is disposed on the lower side of the cutting mechanism 7. The guide member 29 is disposed between the cutting mechanism 7 and the accommodating portion 15 in the transport direction of the medium 2. That is, the guide member 29 is disposed between the second cutting mechanism 8 and the accommodating portion 15 in the transport direction of the medium 2. The cutting mechanism 7 is disposed between the second cutting mechanism 8 and the guide member 29 in the transport direction of the medium 2. The guide member 29 is disposed at a position where the to-be-cut portion 2a and the first margin portion 2b are formed in the left-right direction.

As described above, the medium winding unit 17 is disposed behind the cutting mechanism 7 and the accommodating portion 15. The second margin portion 2c moves from the lower end of the front surface of the cutting platen 31 toward the back side. On the other hand, the accommodating portion 15 is disposed on the lower side of the cutting mechanism 7, and the to-be-cut portion 2a and the first margin portion 2b move toward the lower side. The guide member 29 guides the to-be-cut portion 2a and the first margin portion 2b to the front lower side such that the to-be-cut portion 2a and the first margin portion 2b separate from the second margin portion 2c. That is, the guide member 29 guides the to-be-cut portion 2a and the first margin portion 2b in a direction away from the second margin portion 2c in the front-back direction that is the thickness direction of the medium 2.

As illustrated in FIG. 3, the guide member 29 includes a to-be-fixed member 58 to be fixed to the cutting platen 31, and a contact member 59 that comes into contact with the to-be-cut portion 2a and the first margin portion 2b. The to-be-fixed member 58 is fixed to the cutting platen 31 on the lower side than the opposing portion 31a. The to-be-fixed member 58 is fixed to the front lower end portion of the cutting platen 31. The contact member 59 is attached to the to-be-fixed member 58. The front surface of the contact member 59 is disposed on the front side than the front surface of the cutting platen 31. The front surface of the contact member 59 is, for example, a flat surface orthogonal to the front-back direction. The to-be-cut portion 2a and the first margin portion 2b pass through the front side of the contact member 59.

The attachment position of the contact member 59 with respect to the to-be-fixed member 58 in the front-back direction is adjustable. That is, the attachment position of the contact member 59 with respect to the to-be-fixed member 58 in the thickness direction of the medium 2 is adjustable. The contact member 59 is fixed to the to-be-fixed member 58 by, for example, a bolt and a nut. The to-be-fixed member 58 is formed with a bolt insertion hole having a long hole shape whose longitudinal direction is the front-back direction.

According to the study by the inventors of the present application, in a case where the guide member 29 is not installed, when the second margin portion 2c wound by the medium winding mechanism 26 and moved toward the medium winding unit 17 is inclined to the to-be-cut portion 2a side moved toward the accommodating portion 15, as illustrated in FIG. 8(B), at a predetermined position P on the downstream side of the cutting mechanism 7 in the transport direction of the medium 2, the end face of the to-be-cut portion 2a and the end face of the second margin portion 2c come into contact with each other with an excessive contact pressure, and wrinkles may occur in the to-be-cut portion 2a, or a jam in which the to-be-cut portion 2a and the second margin portion 2c are jammed may occur.

In the present embodiment, the guide member 29 is installed, and the to-be-cut portion 2a is guided in a direction away from the second margin portion 2c by the guide member 29. Therefore, even if the second margin portion 2c wound by the medium winding mechanism 26 and moved toward the medium winding unit 17 is inclined to the to-be-cut portion 2a side moved toward the accommodating portion 15, the end face of the to-be-cut portion 2a guided in the direction away from the second margin portion 2c and the end face of the second margin portion 2c can be prevented from coming into contact with each other with an excessive contact pressure. When the guide member 29 is installed, the to-be-cut portion 2a and the second margin portion 2c are separated from each other in the front-back direction at the predetermined position P, and when viewed from the front side, the end portion of the second margin portion 2c overlaps the to-be-cut portion 2a (see FIG. 8(A)).

### (Configuration of Tension Applying Mechanism)

FIG. 9 is a side view of the first sensor 48 and the second sensor 49 for detecting the position of the tension bar 9 illustrated in FIG. 3.

The tension applying mechanism 10 includes, in addition to the tension bar 9, a tension coil spring 46 (see FIG. 3) serving as a biasing member that biases the tension bar 9 in a direction of pressing the tension bar 9 against the medium 2, and a bar holding portion 47 that movably holds the tension bar 9. The tension applying mechanism 10 also includes a first sensor 48 and a second sensor 49 for detecting the position of the tension bar 9. The tension bar 9 is disposed behind the front surface of the cutting platen 31. The tension bar 9 is disposed behind the lower end of the guide surface 25a of the after platen 25.

The tension bar 9 includes a supporting shaft 50 formed in an elongated circular column shape, and a roller 51 rotatably held by the supporting shaft 50. The supporting shaft 50 is disposed such that the axial direction of the supporting shaft 50 coincides with the left-right direction. The roller 51 is formed in a circular column shape elongated in the left-right direction. The length (length in the left-right direction) of the roller 51 is shorter than the length (length in the left-right direction) of the supporting shaft 50. A supporting shaft 50 is inserted through the inner peripheral side of the roller 51, and the roller 51 is rotatable with respect to the supporting shaft 50 with the left-right direction as an axial direction of rotation. The roller 51 is in contact with the front surface side of the medium 2. Both end portions of the supporting shaft 50 project outward in the left-right direction from both ends of the roller 51.

The bar holding portion 47 supports each of both end portions of the supporting shaft 50. The bar holding portion 47 is formed on the supporting member 52 disposed on both sides of the roller 51 in the left-right direction. A back end portion of the supporting member 52 is fixed to the supporting body 4. A guide groove 47a through which the end portion of the supporting shaft 50 is inserted is formed in the bar holding portion 47. The guide groove 47a is formed in a linear shape (slit shape) having the longitudinal direction as the front-back direction. The supporting shaft 50 is movable in the front-back direction along the guide groove 47a. That is, the tension bar 9 is movable in the front-back direction with respect to the bar holding portion 47.

The tension coil spring 46 is disposed on both sides of the roller 51 in the left-right direction. One end portion of the tension coil spring 46 is engaged with the end portion of the supporting shaft 50, and the other end portion of the tension coil spring 46 is engaged with the supporting member 52. The tension coil spring 46 biases the tension bar 9 toward the back side. That is, the back side (X2 direction side) of the present embodiment is the biasing direction side of the tension bar 9 by the tension coil spring 46. Furthermore, the front side (X1 direction side) is the side opposite to the biasing direction side, and the tension bar 9 is movable with respect to the bar holding portion 47 to the biasing direction side and the side opposite to the biasing direction side of the tension bar 9 by the tension coil spring 46.

Each of the first sensor 48 and the second sensor 49 is a transmissive optical sensor including a light emitting unit and a light receiving unit, and the light emitting unit and the light receiving unit are disposed facing each other with a space therebetween. The first sensor 48 and the second sensor 49 are attached to the supporting member 52. The first sensor 48 and the second sensor 49 are disposed in a state of being spaced apart from each other in the front-back direction. In the present embodiment, the first sensor 48 is disposed on the back side, and the second sensor 49 is disposed on the front side. Alight shielding member 53 is fixed to the supporting shaft 50 by way of a predetermined member. The light shielding member 53 is formed with a light shielding portion 53a capable of shielding between the light emitting unit and the light receiving unit of the first sensor 48, and a light shielding portion 53b capable of shielding between the light emitting unit and the light receiving unit of the second sensor 49.

As described above, the first sensor 48 is disposed on behind the second sensor 49, and functions to detect the position of the tension bar 9 on the back side. Furthermore, the second sensor 49 also functions to detect the position of the tension bar 9 on the front side. That is, the first sensor 48 functions to detect the position of the tension bar 9 on the biasing direction side of the tension bar 9 by the tension coil spring 46, and the second sensor 49 functions to detect the position of the tension bar 9 on the side opposite to the biasing direction side.

In the present embodiment, the medium transporting mechanism 5 and the second medium transporting mechanism 30 are controlled based on the detection results of the first sensor 48 and the second sensor 49 so that the tension bar 9 is disposed within a predetermined range in the front-back direction. That is, the transportation amount of the medium 2 by the medium transporting mechanism 5 and the transportation amount of the medium 2 by the second medium transporting mechanism 30 are controlled based on the detection results of the first sensor 48 and the second sensor 49 so that the tension of the medium 2 becomes a tension within a predetermined range. Specifically, the transportation amount of the medium 2 is controlled based on the detection results of the first sensor 48 and the second sensor 49 so that the tension bar 9 is disposed at a position where the light shielding portion 53a shields between the light emitting unit and the light receiving unit of the first sensor 48 and the light shielding portion 53b shields between the light emitting unit and the light receiving unit of the second sensor 49.

### (Printing Method and Cutting Method of Medium)

FIG. 10 is a block diagram for explaining a configuration of the printing and cutting device 1 illustrated in FIG. 1.

When printing is performed on the medium 2 by the printing mechanism 3, the printing and cutting device 1 of the present embodiment cuts the medium 2 by the cutting mechanism 7 and the second cutting mechanism 8 as it is, and cuts out the to-be-cut portion 2a. In the present embodiment, the medium 2 that has passed through the after platen 25 after printing moves toward the tension bar 9 as indicated by the solid line in FIG. 1. When cutting out the to-be-cut portion 2a, the second medium transporting mechanism 30 transports the medium 2 on the cutting platen 31, so that the second cutting mechanism 8 forms the cut lines CL11 to CL14 along the medium transport direction on the medium 2. When the carriage 34 moves in the left-right direction while the medium 2 on the cutting platen 31 is stopped, the cutting mechanism 7 forms a cut line CL1 parallel to the medium width direction (left-right direction).

When a cutting position (i.e., the position where the cut line CL1 is formed in the medium transport direction) in the medium transport direction of the medium 2, which is linearly cut in the left-right direction by the cutting mechanism 7 after the printing, is defined as a medium cutting position, the printing mechanism 3 prints an image on the medium 2 and prints a cutting position mark (registration mark) M1 for specifying the medium cutting position on the medium 2, as illustrated in FIG. 2. The printing mechanism 3 prints the cutting position mark M1 on one end portion of the medium 2 in the left-right direction.

The cutting position mark M1 is a straight line (line segment) parallel to the left-right direction, and is printed on a portion of the medium 2 that becomes the second margin portion 2c. Furthermore, the cutting position mark M1 is printed at a position separated by a certain distance on the downstream side in the transport direction from the medium cutting position. That is, the printing mechanism 3 prints the plurality of cutting position marks M1 at positions separated by a certain distance on the downstream side in the transport direction from each of the plurality of medium cutting positions. The plurality of cutting position marks M1 are printed at the same position in the left-right direction.

When a cutting range (i.e., the range in which the cut line CL1 is formed in the left-right direction) of the medium 2 at the medium cutting position in the medium width direction (left-right direction) is defined as a medium cutting range, and a cutting position (i.e., positions where the cut lines CL11 to CL14 are formed in the left-right direction) of the medium 2, which is linearly cut in the transport direction of the medium 2 by the second cutting mechanism 8 after printing, in the left-right direction is defined as a second medium cutting position, in a personal computer (PC) 61 electrically connected to the printing and cutting device 1, image data that is data of an image (specifically, an image to be printed on the to-be-cut portion 2a) to be printed on the medium 2, cutting position data that is data for specifying the medium cutting position, mark printing data that is data for printing the cutting position mark M1, cutting range data that is data for specifying the medium cutting range, and second cutting position data that is data for specifying the second medium cutting position are created.

For example, the operator of the printing and cutting device 1 creates these pieces of data on the display of the PC 61. Software for image creation and the like are installed in the PC 61. In the present embodiment, a printing system is configured by the printing and cutting device 1 and the PC 61. When these pieces of data are created in the PC 61, for example, the operator adjusts the position of the second cutting mechanism 8 in the left-right direction while checking the second medium cutting position displayed on the display of the PC 61, and fixes the second cutting mechanism 8 to the supporting frame 35.

Furthermore, when the operator performs a predetermined operation on the PC 61, the PC 61 transmits the created image data, cutting position data, mark printing data, and cutting range data to the print control unit 62 that is the control unit of the printing mechanism 3, and the print control unit 62 receives these pieces of data. That is, the printing mechanism 3 receives these pieces of data. The mark printing data includes mark position data that is data for specifying the position of the cutting position mark M1 in the left-right direction.

The print control unit 62 that received the image data, the cutting position data, the mark printing data, and the cutting range data corrects the cutting position data, the cutting range data, and the mark position data based on the data of the position in the left-right direction of the medium 2 held by the print control unit 62, and transmits the cutting position data, cutting range data, and mark position data after the correction to the cutting control unit 63 that is the control unit of the cutting mechanism 7, and the cutting control unit 63 receives these pieces of data. That is, the cutting mechanism 7 receives these pieces of data.

The cutting control unit 63 that received the cutting position data, the cutting range data, and the mark position data moves the carriage 34 to a position where the sensor 56 can detect the cutting position mark M1 based on the mark position data. That is, the carriage driving mechanism 36 moves the carriage 34 to a position where the sensor 56 can detect the cutting position mark M1 based on the mark position data. When the medium 2 is cut by the cutting mechanism 7, this position becomes the reference position of the carriage 34, and the carriage 34 starts to move from this position. In this state, the printing mechanism 3 prints an image on the medium 2 based on the image data, and prints the cutting position mark M1 on the medium 2 based on the mark printing data.

Furthermore, the cutting mechanism 7 cuts the medium 2 based on the cutting range data. When the cutting mechanism 7 cuts the medium 2, the medium 2 on the cutting platen 31 is stopped. The stop position of the medium 2 is controlled based on the detection result of the sensor 56 and the cutting position data. Specifically, when the medium 2 is transported by a predetermined amount by the second medium transporting mechanism 30 after the sensor 56 detects the cutting position mark M1, the medium 2 is stopped and the cutting mechanism 7 cuts the medium 2.

In the present embodiment, when the light shielding portion 53a of the light shielding member 53 shields between the light emitting unit and the light receiving unit of the first sensor 48 and the light shielding portion 53b shields between the light emitting unit and the light receiving unit of the second sensor 49, the carriage 34 can move in the left-right direction. That is, when the cutting mechanism 7 forms the cut line CL1, the tension bar 9 is disposed at a position where the light shielding portion 53a shields between the light emitting unit and the light receiving unit of the first sensor 48, and the light shielding portion 53b shields between the light emitting unit and the light receiving unit of the second sensor 49. Furthermore, in the present embodiment, even if the tension bar 9 is moved in the front-back direction by a predetermined range, a state in which the light shielding portion 53a shields between the light emitting unit and the light receiving unit of the first sensor 48 and the light shielding portion 53b shields between the light emitting unit and the light receiving unit of the second sensor 49 is maintained.

### Main Effect of Present Embodiment

As described above, in the printing and cutting device 1 of the present embodiment, the tension bar 9 biased toward the back side by the tension coil spring 46 is disposed between the printing mechanism 3 and the cutting mechanism 7 in the transport direction of the medium 2, and is movable in the front-back direction with respect to the bar holding portion 47. Thus, in the present embodiment, even if the printing mechanism 3 performs printing on the medium 2 during the cutting of the medium 2 by the cutting mechanism 7 and transports the medium 2 toward the cutting mechanism 7, the tension of the portion of the medium 2 being cut by the cutting mechanism 7 can be maintained by the tension bar 9, and as a result, the medium 2 can be appropriately cut by the cutting mechanism 7.

Therefore, in the present embodiment, printing of the medium 2 by the printing mechanism 3 can be performed even during the cutting of the medium 2 by the cutting mechanism 7 and the medium 2 can be transported toward the cutting mechanism 7. Note that in the present embodiment, since the heater 6 is disposed between the printing mechanism 3 and the tension bar 9 in the transport direction of the medium 2, the distance between the printing mechanism 3 and the cutting mechanism 7 in the transport direction of the medium 2 becomes long, but in the present embodiment, even if the distance between the printing mechanism 3 and the cutting mechanism 7 in the transport direction of the medium 2 becomes long, the printing of the medium 2 by the printing mechanism 3 can be performed during the cutting of the medium 2 by the cutting mechanism 7 and the medium 2 can be transported toward the cutting mechanism 7.

In this embodiment, the tension bar 9 is disposed between the printing mechanism 3 and the second cutting mechanism 8 in the transport direction of the medium 2, and is movable in the front-back direction with respect to the bar holding portion 47. In the present embodiment, the transport roller 32 and the pad roller 33 of the second medium transporting mechanism 30 are disposed between the tension bar 9 and the second cutting mechanism 8. Therefore, in the present embodiment, even in a state where the portion of the medium 2 where the printing by the printing mechanism 3 is being performed is stopped while the printing of the medium 2 by the printing mechanism 3 is being performed, the portion of the medium 2 to be cut by the second cutting mechanism 8 can be transported by the second medium transporting mechanism 30 by the amount the tension bar 9 moves, and the cutting of the medium 2 can be performed by the second cutting mechanism 8.

Therefore, in the present embodiment, the cutting of the medium 2 can be performed by the second cutting mechanism 8 even during the printing of the medium 2 by the printing mechanism 3. Note that in the present embodiment, since the heater 6 is disposed between the printing mechanism 3 and the tension bar 9 in the transport direction of the medium 2, the distance between the printing mechanism 3 and the second cutting mechanism 8 in the transport direction of the medium 2 becomes long, but in the present embodiment, even if the distance between the printing mechanism 3 and the second cutting mechanism 8 in the transport direction of the medium 2 becomes long, the cutting of the medium 2 can be performed by the second cutting mechanism 8 while performing printing of the medium 2 by the printing mechanism 3.

In this embodiment, the tension bar 9 can suppress a variation in the tension of the medium 2 when cutting is performed by the cutting mechanism 7 and a variation in the tension of the medium 2 when cutting is performed by the second cutting mechanism 8. Therefore, in the present embodiment, the state of the medium 2 at the time of cutting by the cutting mechanism 7 and the state of the medium 2 at the time of cutting by the second cutting mechanism 8 can be stabilized.

Furthermore, in the present embodiment, the tension applying mechanism 10 includes the first sensor 48 and the second sensor 49 for detecting the position of the tension bar 9 in the front-back direction, and the transportation amount of the medium 2 is controlled based on the detection results of the first sensor 48 and the second sensor 49 so that the tension of the medium 2 becomes the tension within a predetermined range. Thus, in the present embodiment, the variation in the tension of the medium 2 when the cutting is performed by the cutting mechanism 7 and the variation in the tension of the medium 2 when the cutting is performed by the second cutting mechanism 8 can be effectively suppressed.

Furthermore, in the present embodiment, a medium pressing member 44 for pressing the medium 2 toward the opposing portion 31a of the cutting platen 31 is attached to the carriage 34, and the medium pressing member 44 is formed with an opposing surface 44a facing the opposing portion 31a. Furthermore, in the present embodiment, assuming that the advancing direction side of the carriage 34 when the cutter blade 38 cuts the medium 2 is the first direction side, an inclined surface 44d inclined toward the side away from the opposing portion 31a toward the first direction side is formed at the end portion on the first direction side of the opposing surface 44a, and the inclined surface 44d is disposed on the first direction side of the cutter blade 38.

Thus, in the present embodiment, when the medium 2 starts to be cut in the width direction of the medium 2 by the cutter blade 38, even if the end portion in the width direction of the medium 2 (specifically, the end portion on the second direction side of the portion of the medium 2 that becomes the to-be-cut portion 2a and the first margin portion 2b, hereinafter, the end portion of this portion of the medium 2 is referred to as “the end portion in the width direction of the first medium portion”) is lofted from the opposing portion 31a, the end portion in the width direction of the first medium portion floating from the opposing portion 31a can be guided to the medium pressing surface 44f by the inclined surface 44d, and as a result, the medium 2 can be started to be cut with the cutter blade 38 while pressing the end portion in the width direction of the first medium portion floating from the opposing portion 31a toward the opposing portion 31a with the medium pressing member 44. Therefore, in this embodiment, even if the end portion in the width direction of the first medium portion is floated from the opposing portion 31a when the medium 2 starts to be cut in the width direction of the medium 2, the interference between the carriage 34 and the like and the end portion in the width direction of the first medium portion can be prevented, and as a result, the medium 2 can be appropriately cut by the cutting mechanism 7.

Note that in this embodiment, since the accommodating portion 15 is disposed on the lower side of the cutting mechanism 7 and the second cutting mechanism 8, the end portion of the first medium portion in the width direction may be easily floated from the opposing portion 31a due to the influence of the contact of the portion of the medium 2 that becomes the to-be-cut portion 2a and the first margin portion 2b with the bottom surface of the accommodating portion 15 and the influence of the weight of the portion of the medium 2 that becomes the to-be-cut portion 2a and the first margin portion 2b, but in this embodiment, even if the end portion of the first medium portion in the width direction is easily floated from the opposing portion 31a, the medium 2 can be started to be cut with the cutter blade 38 while pressing down the end portion of the first medium portion in the width direction floating from the opposing portion 31a toward the opposing portion 31a with the medium pressing member 44, and hence the interference between the carriage 34 and the like and the end portion in the width direction of the first medium portion can be prevented, and the medium 2 can be appropriately cut by the cutting mechanism 7.

Furthermore, in the present embodiment, since the cutter blade 38 is a single-edged blade, if the end portion in the width direction of the first medium portion is floated from the opposing portion 31a when the medium 2 starts to be cut with the cutter blade 38 in the width direction of the medium 2, a portion other than the sharp portion of the cutter blade 38 and the end portion in the width direction of the first medium portion interfere with each other, and the medium 2 may not be appropriately cut, but in the present embodiment, even if the end portion in the width direction of the first medium portion is floated from the opposing portion 31a when the medium 2 starts to be cut in the width direction of the medium 2, the medium 2 can start to be cut with the cutter blade 38 while pressing the end portion in the width direction of the first medium portion floating from the opposing portion 31a toward the opposing portion 31a with the medium pressing member 44, and thus the interference between the portion other than the sharp portion of the cutter blade 38 and the end portion in the width direction of the first medium portion can be prevented and the medium 2 can be appropriately cut by the cutting mechanism 7.

In this embodiment, the guide member 29 is disposed between the cutting mechanism 7 and the second cutting mechanism 8 and the accommodating portion 15 in the transport direction of the medium 2, and the guide member 29 guides the to-be-cut portion 2a and the first margin portion 2b in a direction away from the second margin portion 2c in the thickness direction of the medium 2. Therefore, in the present embodiment, as described above, even if the second margin portion 2c wound by the medium winding mechanism 26 and moved toward the medium winding unit 17 is inclined toward the to-be-cut portion 2a side moved toward the accommodating portion 15, the end face of the to-be-cut portion 2a guided in the direction away from the second margin portion 2c by the guide member 29 and the end face of the second margin portion 2c can be prevented from coming into contact with each other with an excessive contact pressure.

In the present embodiment, the guide member 29 includes the to-be-fixed member 58 fixed to the cutting platen 31 and the contact member 59 that comes into contact with the to-be-cut portion 2a and the first margin portion 2b, and the attachment position of the contact member 59 with respect to the to-be-fixed member 58 in the front-rear direction is adjustable. Therefore, in the present embodiment, the direction in which the guide member 29 guides the to-be-cut portion 2a and the first margin portion 2b is adjustable. Therefore, in the present embodiment, even if the second margin portion 2c wound by the medium winding mechanism 26 and moved toward the medium winding unit 17 is inclined toward the to-be-cut portion 2a side moved toward the accommodating portion 15, the end face of the to-be-cut portion 2a guided in the direction away from the second margin portion 2c by the guide member 29 and the end face of the second margin portion 2c can be effectively prevented from coming into contact with each other with an excessive contact pressure.

Note that in the present embodiment, since the to-be-cut portion 2a and the first margin portion 2b are guided to the front lower side by the guide member 29, the end portion in the width direction of the first medium portion may be easily floated from the opposing portion 31a when the medium 2 starts to be cut in the width direction of the medium 2 by the cutting mechanism 7, but in the present embodiment, even if the end portion in the width direction of the first medium portion is easily floated from the opposing portion 31a, the medium 2 can start to be cut with the cutter blade 38 while pressing the end portion in the width direction of the first medium portion floating from the opposing portion 31a toward the opposing portion 31a by the medium pressing member 44, and thus interference between the carriage 34 and the like and the end portion in the width direction of the first medium portion can be prevented, and the medium 2 can be appropriately cut by the cutting mechanism 7.

Furthermore, in the present embodiment, since the to-be-cut portion 2 a and the first margin portion 2b are guided to the front lower side by the guide member 29 disposed on the lower side of the cutting mechanism 7, the end portion in the width direction of the first medium portion is more likely to float from the opposing portion 31a toward the lower side, but in the present embodiment, the lower end portion of the inclined surface forming portion 44g of the medium pressing member 44 is an inclined surface 44h inclined to the upper side toward the first direction side. Therefore, in the present embodiment, even if the end portion in the width direction of the first medium portion is more likely to float from the opposing portion 31a toward the lower side, the contact between the end portion in the width direction of the first medium portion floating from the opposing portion 31a and the end portion on the first direction side of the inclined surface forming portion 44g can be prevented, and the end portion in the width direction of the first medium portion floating from the opposing portion 31a can be pressed by the inclined surface forming portion 44g.

### Second Embodiment

### (Configuration of Printing and Cutting Device, and Printing Method and Cutting Method of Medium)

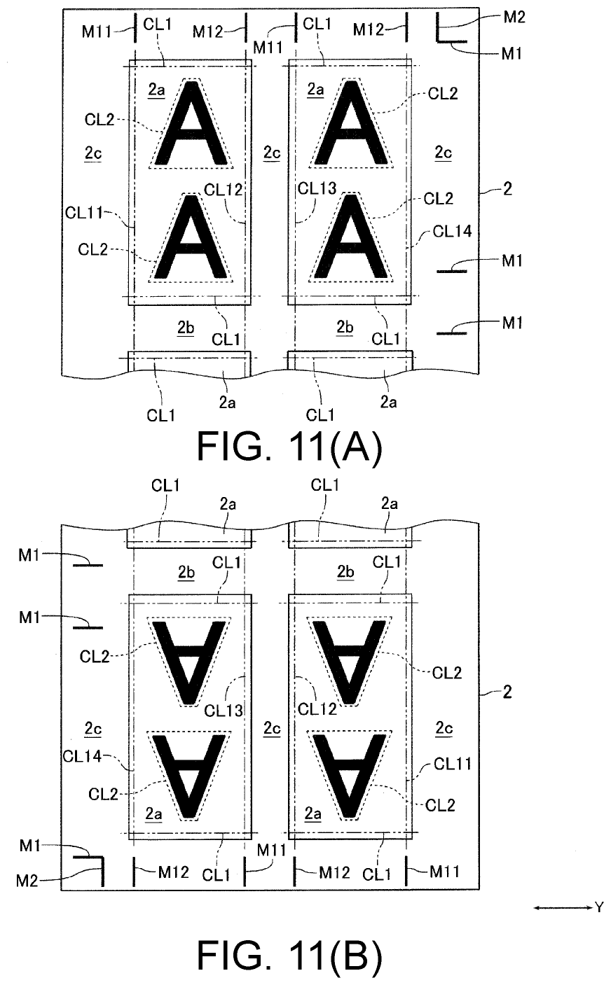

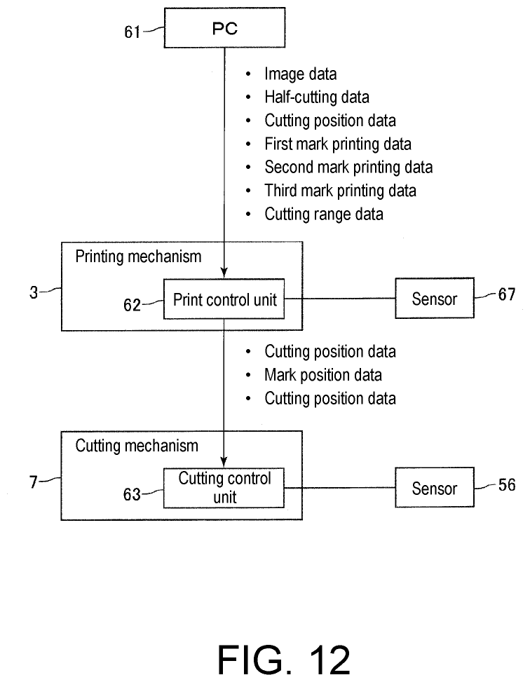

FIG. 11 is a diagram for describing a printing method and a cutting method of a medium 2 according to a second embodiment of the present invention. FIG. 12 is a block diagram for explaining a configuration of a printing and cutting device 1 according to the second embodiment of the present invention.

Similarly to the printing and cutting device 1 of the first embodiment, the printing and cutting device 1 of the present embodiment performs printing on the long medium 2 and cuts the long medium 2. In the printing and cutting device 1 of the first embodiment, printing of the medium 2 by the printing mechanism 3 and cutting of the medium 2 by the cutting mechanism 7 and the second cutting mechanism 8 are performed. On the other hand, in the present embodiment, for example, the medium 2 includes a mount and a sealing material strippably attached to the mount, where in the printing and cutting device 1, half cutting of the medium 2 in which only the sealing material is cut into a predetermined shape according to the image printed on the sealing material of the medium 2 is performed in addition to the printing of the medium 2 by the printing mechanism 3 and the cutting of the medium 2 by the cutting mechanism 7 and the second cutting mechanism 8. Hereinafter, the configuration and the like of the printing and cutting device 1 of the present embodiment will be described focusing on differences from the first embodiment.

The printing mechanism 3 of the present embodiment includes a cutting head 66 (see FIG. 1) for half-cutting the medium 2. The cutting head 66 is mounted on the carriage 21 and is movable in the left-right direction. The cutting head 66 includes, for example, a cutter blade, a cutter holder that turnably holds the cutter blade so that the cutter blade can turn with the up-down direction as an axial direction of turning, and a raising/lowering mechanism that raises and lowers the cutter holder. The medium 2 is half-cut by the cutting head 66 after printing of the medium 2.

When a portion of the medium 2 half-cut by the cutting head 66 is defined as a half-cut line CL2, for example, as illustrated in FIG. 11, a half-cut line CL2 surrounding an image is formed on the medium 2 half-cut by the cutting head 66. When the medium 2 is half-cut, the transportation of the medium 2 to both sides in the medium transport direction, that is, the transportation of the medium 2 to the downstream side in the transport direction and the transportation of the medium 2 to the upstream side in the transport direction is performed.

When the medium 2 is sandwiched between the transport roller 32 and the pad roller 33 in the stopped state, the medium 2 cannot be transported to the upstream side in the transport direction by greater than or equal to a predetermined amount by the medium transporting mechanism 5. Furthermore, even if the pad roller 33 can be retracted and a situation where the medium 2 is not sandwiched between the transport roller 32 and the pad roller 33 can be created, if the medium 2 is cut by the cutting mechanism 7 and the second cutting mechanism 8 in a situation where the medium 2 is transported to both sides in the medium transport direction, the medium 2 may not be appropriately cut in the medium width direction and the medium transport direction due to the influence of the medium 2 being transported to the upstream side in the transport direction.

Therefore, in the present embodiment, the medium 2 after being subjected to the printing and the half-cutting is once wound into a roll by the medium winding mechanism 26 without being cut by the cutting mechanism 7 and the second cutting mechanism 8, and then the operator detaches the roll-shaped medium 2 from the medium winding unit 17 and attaches it to the medium feeding unit 14. Furthermore, the medium 2 after the printing and the half-cutting wound into a roll shape is again unwound from the medium feeding unit 14, and cut by the cutting mechanism 7 and the second cutting mechanism 8. That is, when the medium 2 after being subjected to printing by the printing mechanism 3 and after being detached from the medium winding unit 17 is assumed as a post-printing medium, the post-printing medium wound in a roll shape is attached to the medium take-out unit 14. Furthermore, the cutting mechanism 7 and the second cutting mechanism 8 cut the post-printing medium.

In this embodiment, the downstream end in the transport direction of the medium 2 when performing the printing and the half-cutting becomes the upstream end in the transport direction of the medium 2 when performing cutting by the cutting mechanism 7 and the second cutting mechanism 8, and the upstream end in the transport direction of the medium 2 when performing the printing and the half-cutting becomes the downstream end in the transport direction of the medium 2 when performing cutting by the cutting mechanism 7 and the second cutting mechanism 8. Furthermore, the right end of the medium 2 when performing the printing and the half-cutting becomes the left end of the medium 2 when performing cutting by the cutting mechanism 7 and the second cutting mechanism 8, and the left end of the medium 2 when performing the printing and the half-cutting becomes the right end of the medium 2 when performing cutting by the cutting mechanism 7 and the second cutting mechanism 8.

Note that FIG. 11(A) is a view for explaining a state of the end portion on the upstream side in the transport direction of the medium 2 after the printing and the half-cutting are finished and before the medium 2 is detached from the medium winding unit 17, and FIG. 11(B) is a view for explaining a state of the end portion on the downstream side in the transport direction of the medium 2 attached to the medium feeding unit 14 after the printing and the half-cutting are finished and the medium 2 is detached from the medium winding unit 17.

In the present embodiment, since the medium 2 is not cut by the cutting mechanism 7 and the second cutting mechanism 8 when the printing and the half-cutting of the medium 2 are performed, the medium 2 that has passed through the after platen 25 after the printing and the half-cutting passes through the front side of the cutting mechanism 7, the second cutting mechanism 8, and the tension applying mechanism 10, passes through the lower side of the cutting mechanism 7, and then is wound by the medium winding mechanism 26, as illustrated by a two-dot chain line in FIG. 1. On the other hand, when the medium 2 is cut by the cutting mechanism 7 and the second cutting mechanism 8, as in the first embodiment, the medium 2 that has passed through the after platen 25 is moved toward the tension bar 9 (see the solid line in FIG. 1). When the medium 2 is cut by the cutting mechanism 7 and the second cutting mechanism 8, the medium 2 passes on the print platen 24.

In the present embodiment, when the printing and the half-cutting of the medium 2 are performed, the medium winding unit 17 holds the winding roll 16 around which the medium 2 subjected to the printing and half-cutting is wound in a roll shape. On the other hand, when the medium 2 is cut by the cutting mechanism 7 and the second cutting mechanism 8, the medium winding unit 17 holds the winding roll 16 around which the second margin portion 2c is wound in a roll shape as in the first embodiment.

In the present embodiment, a sensor 67 (see FIG. 12) for detecting a first cutting range mark M11 and a second cutting range mark M12 to be described later to be printed on the medium 2 is mounted on the carriage 21 of the printing mechanism 3. That is, the printing and cutting device 1 includes the sensor 67 for detecting the first cutting range mark M11 and the second cutting range mark M12, and the sensor 67 is disposed on the upstream side in the transport direction of the cutting mechanism 7. The sensor 67 is a reflective optical sensor similar to the sensor 56, and includes a light emitting unit and a light receiving unit that receives light emitted from the light emitting unit and reflected by the medium 2. The light emitting unit of the sensor 67 emits light toward the lower side. The sensor 67 is electrically connected to the print control unit 62.

Similarly to the first embodiment, assuming that the cutting range (i.e., the range in which the cut line CL1 is formed in the left-right direction) of the medium 2 in the left-right direction at the medium cutting position is the medium cutting range, the printing mechanism 3 of the present embodiment prints the image and the cutting position mark M1 on the medium 2, and prints the first cutting range mark M11 disposed at a position corresponding to one end of the medium cutting range in the left-right direction, the second cutting range mark M12 disposed at a position corresponding to the other end of the medium cutting range in the left-right direction, and the origin specifying mark M2 for specifying the origin on the medium 2.

Similarly to the first embodiment, the cutting position mark M1 is a straight line (line segment) parallel to the left-right direction, and the printing mechanism 3 prints the cutting position mark M1 on one end portion in the left-right direction of the medium 2 to be the second margin portion 2c. Furthermore, the cutting position mark M1 of the present embodiment is printed at a position separated from the medium cutting position by a certain distance on the upstream side in the transport direction (see FIG. 11 (A)). That is, the printing mechanism 3 prints the plurality of cutting position marks M1 at positions separated by a certain distance on the upstream side in the transport direction from each of the plurality of medium cutting positions.

The first cutting range mark M11 and the second cutting range mark M12 are straight lines (line segments) parallel to the medium transport direction. The printing mechanism 3 prints the first cutting range mark M11 and the second cutting range mark M12 at the end portion on the upstream side in the transport direction of the medium 2 wound by the medium winding unit 17. For example, as illustrated in FIG. 11, when two to-be-cut portions 2 a are arranged side by side in the width direction of the medium 2, the printing mechanism 3 prints two first cutting range marks M11 and two second cutting range marks M12.

In the present embodiment, the printing mechanism 3 prints the first cutting range mark M11 on the inner side in the left-right direction from one end of the medium cutting range in the left-right direction, and prints the second cutting range mark M12 on the inner side in the left-right direction from the other end of the medium cutting range in the left-right direction. Similarly to the first embodiment, assuming that the cutting position (i.e., positions where the cut lines CL11 to CL14 are formed in the left-right direction) in the left-right direction of the medium 2 linearly cut in the medium transport direction by the second cutting mechanism 8 is the second medium cutting position, the printing mechanism 3 prints the first cutting range mark M11 and the second cutting range mark M12 at the same position as the second medium cutting position in the left-right direction.

Note that the printing mechanism 3 may print the first cutting range mark M11 and the second cutting range mark M12 on the first margin portion 2b at a predetermined pitch in the medium transport direction in addition to the first cutting range mark M11 and the second cutting range mark M12 printed on the end portion on the upstream side in the transport direction of the medium 2 wound by the medium winding unit 17.

The origin specifying mark M2 is a straight line (line segment) parallel to the medium transport direction. The printing mechanism 3 prints the origin mark M2 on the end portion on the upstream side in the transport direction of the medium 2 wound by the medium winding unit 17. Furthermore, for example, the downstream end in the transport direction of the origin specifying mark M2 is connected to the inner end in the left-right direction of the cutting position mark M1 printed on the most upstream side in the transport direction, and the origin specifying mark M2 is printed on one end portion in the left-right direction of the medium 2 to be the second margin portion 2c.

In this embodiment, before the printing and the half-cutting of the medium 2 are performed, the PC 61 creates image data that is data of an image (specifically, an image to be printed on the to-be-cut portion 2a) to be printed on the medium 2, half-cutting data that is data for half-cutting the medium 2, cutting position data that is data for specifying the medium cutting position, first mark printing data that is data for printing the cutting position mark M1 on the medium 2, cutting range data that is data for specifying the medium cutting range, and second cutting position data that is data for specifying the second medium cutting position. Before the printing and the half-cutting of the medium 2 are performed, the PC 61 creates second mark printing data that is data for printing the first cutting range mark M11 and the second cutting range mark M12 on the medium 2 and third mark printing data that is data for printing the origin specifying mark M2 on the medium 2.

For example, the operator of the printing and cutting device 1 creates these pieces of data on the display of the PC 61. When the operator performs a predetermined operation on the PC 61 after these pieces of data are created by the PC 61, the PC 61 transmits the created image data, half-cutting data, cutting position data, first mark printing data, second mark printing data, third mark printing data, and cutting range data to the print control unit 62, and the print control unit 62 receives these pieces of data. That is, the printing mechanism 3 receives these pieces of data.

The printing mechanism 3 that has received the data prints an image on the medium 2 based on the image data, prints a plurality of cutting position marks M1 on the medium 2 based on the first mark printing data, prints a first cutting range mark M11 and a second cutting range mark M12 based on the second mark printing data, and prints an origin specifying mark M2 based on the third mark printing data. Furthermore, after the printing of the medium 2, the printing mechanism 3 half-cuts the medium 2 based on the half-cutting data. As described above, when the printing and the half-cutting of the medium 2 are performed, the medium 2 is set so that the medium 2 that has passed through the after platen 25 after the printing and the half-cutting passes through the front side of the cutting mechanism 7, the second cutting mechanism 8, and the tension applying mechanism 10, and the lower side of the cutting mechanism 7, and then is wound by the medium winding mechanism 26.

The medium 2 subjected to the printing and the half-cutting is wound into a roll by the medium winding mechanism 26 and detached from the medium winding unit 17 by the operator. The roll-shaped medium 2 after the printing and the half-cutting detached from the medium winding unit 17 is attached to the medium feeding unit 14 by an operator. The roll-shaped medium 2 attached to the medium feeding unit 14 is pulled out by the operator, and the end portion on the downstream side in the transport direction of the medium 2 is disposed on the print platen 24.

Thereafter, the sensor 67 detects the origin specifying mark M2 and also detects the cutting position mark M1 (i.e., the cutting position mark M1 printed on the most downstream side in the transport direction) connected to the upstream end in the transport direction of the origin specifying mark M2. The print control unit 62 specifies the origin position based on the detection results of the sensor 67. In this embodiment, for example, the position of the connecting point between the origin specifying mark M2 and the cutting position mark M1 becomes the origin position of the medium 2. Thereafter, the sensor 67 detects the first cutting range mark M11 and the second cutting range mark M12.

When the sensor 67 detects the origin specifying mark M2, the first cutting range mark M11, and the second cutting range mark M12, the carriage 21 moves in the left-right direction. Furthermore, when the sensor 67 detects the cutting position mark M1, the medium transporting mechanism 5 transports the medium 2. Note that before the sensor 67 detects the origin specifying mark M2 and the cutting position mark M1, the position of the carriage 21 in the left-right direction and the position of the end portion on the downstream side in the transport direction of the medium 2 in the medium transport direction are adjusted by the operator. Specifically, a laser pointer that emits a laser beam toward the lower side is mounted on the carriage 21, and the operator adjusts the position of the carriage 21 and the position of the end portion on the downstream side in the transport direction of the medium 2 while checking the laser beam with which the medium 2 is irradiated from the laser pointer.

The print control unit 62 generates mark position data that is data for specifying the position of the cutting position mark M1 in the left-right direction based on the detection result of the cutting position mark M1 by the sensor 67, and corrects the cutting range data based on the detection results and the like of the first cutting range mark M11 and the second cutting range mark M12 by the sensor 67 to generate corrected cutting range data. The print control unit 62 then transmits the cutting position data, the mark position data, and the corrected cutting range data to the cutting control unit 63, and the cutting control unit 63 receives these pieces of data. That is, the cutting mechanism 7 receives these pieces of data.

The cutting control unit 63 that received the cutting position data, the cutting range data, and the mark position data moves the carriage 34 to a position where the sensor 56 can detect the cutting position mark M1 based on the mark position data. That is, the carriage driving mechanism 36 moves the carriage 34 to a position where the sensor 56 can detect the cutting position mark M1 based on the mark position data received by the cutting mechanism 7. When the medium 2 is cut by the cutting mechanism 7, this position becomes the reference position of the carriage 34, and the carriage 34 starts to move from this position.

For example, the operator fixes the second cutting mechanism 8 to the supporting frame 35 by adjusting the position of the second cutting mechanism 8 in the left-right direction using the first cutting range mark M11 and the second cutting range mark M12 printed at the same position as the second medium cutting position in the left-right direction as marks. Thereafter, the medium 2 is cut by the second cutting mechanism 8 and the medium 2 is cut by the cutting mechanism 7.

Similarly to the first embodiment, when the second medium transporting mechanism 30 transports the medium 2, the second cutting mechanism 8 cuts the medium 2. The cutting mechanism 7 cuts the medium 2 based on the cutting range data. When the cutting mechanism 7 cuts the medium 2, the medium 2 on the cutting platen 31 is stopped. Similarly to the first embodiment, in the present embodiment as well, the stop position of the medium 2 is controlled based on the detection result of the sensor 56 and the cutting position data. Specifically, when the medium 2 is transported by a predetermined amount by the second medium transporting mechanism 30 after the sensor 56 detects the cutting position mark M1, the medium 2 is stopped and the cutting mechanism 7 cuts the medium 2. At the time of cutting the medium 2 by the cutting mechanism 7, the cutting position mark M1 is disposed at a position away from the medium cutting position toward the downstream side in the transport direction by a certain distance (see FIG. 11(B)).

As described above, in the present embodiment, the cutting mechanism 7 cuts the medium 2 in the left-right direction based on the cutting range data (i.e., the cutting range data received by the cutting mechanism 7 from the print control unit 62) corrected based on the detection results and the like of the first cutting range mark M11 and the second cutting range mark M12 by the sensor 67, and the detection result of the sensor 56. That is, the cutting mechanism 7 cuts the medium 2 in the left-right direction based on the detection results of the sensors 56 and 67.

When the first cutting range mark M11 and the second cutting range mark M12 are printed on the first margin portion 2b, the sensor 67 may detect the origin specifying mark M2, the cutting position mark M1, the first cutting range mark M11, and the second cutting range mark M12 again after the cutting of the medium 2 by the cutting mechanism 7 and the second cutting mechanism 8 is started. In this case, the print control unit 62 generates the mark position data again, corrects the cutting range data, and transmits the cutting position data, the mark position data, and the corrected cutting range data to the cutting control unit 63.

Furthermore, in the second embodiment, instead of performing half-cutting of the medium 2, a perforation having a predetermined shape corresponding to the image printed on the medium 2 may be formed on the medium 2 after printing. In this case, for example, the medium 2 is formed of paper, and the cutting head 66 forms a perforation on the medium 2 after printing. Furthermore, in this case, for example, a cut line of a perforation having the same shape as the half-cut line CL2 is formed on the medium 2. In the second embodiment, instead of performing half-cutting of the medium 2, the medium 2 may be cut out by cutting out a part of the medium 2 after printing for decoration. Furthermore, in the second embodiment, a predetermined process may be performed on the medium 2 instead of half-cutting the medium 2, forming perforations in the medium 2, and cutting out the medium 2. Even in this case, the medium 2 is transported to both sides in the medium transport direction when the predetermined process is performed on the medium 2.

### OTHER EMBODIMENTS

The embodiment described above is an example of a preferred embodiment of the present invention, but the present invention is not limited thereto, and various modified examples can be made within a scope of not changing the gist of the present invention.

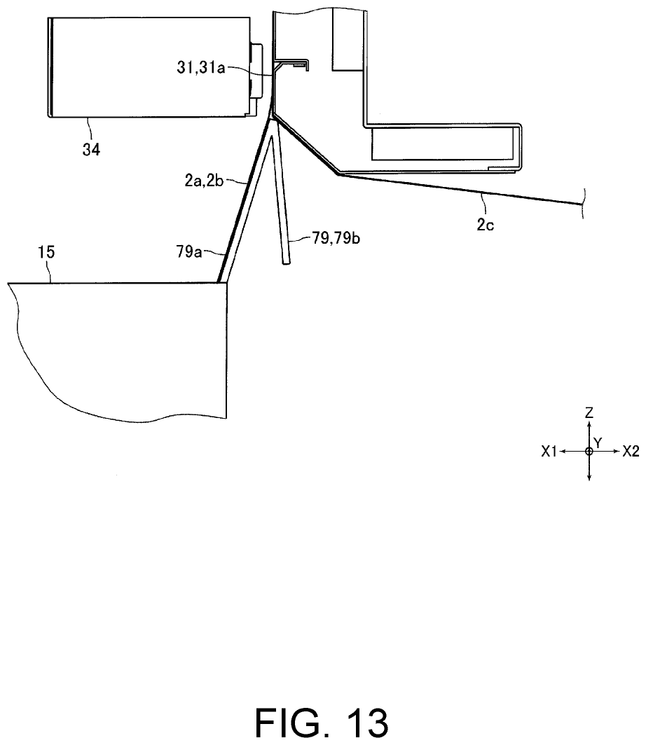

In the embodiment described above, the guide member 29 includes the two members of the to-be-fixed member 58 and the contact member 59, but the guide member 29 may be formed of only one member. In the embodiment described above, the printing and cutting device 1 may include, instead of the guide member 29, a guide member 79 (see FIG. 13) that guides the to-be-cut portion 2a and the first margin portion 2b in a direction away from the second margin portion 2c. The guide member 79 is attached to, for example, the accommodating portion 15. Specifically, the guide member 79 is attached to the back upper end portion of the accommodating portion 15. The guide member 79 is disposed on the lower side of the cutting mechanism 7 and is disposed between the cutting mechanism 7 and the accommodating portion 15 in the medium transport direction. Furthermore, the guide member 79 is disposed at a position where the to-be-cut portion 2a and the first margin portion 2b are formed in the left-right direction.

The guide member 79 is formed with, for example, an inclined surface 79a inclined to the lower side toward the front side, and the to-be-cut portion 2a and the first margin portion 2b pass through the front side of the inclined surface 79a. The to-be-cut portion 2a and the first margin portion 2b are guided to the front lower side so as to be away from the second margin portion 2c by the inclined surface 79a. Furthermore, the guide member 79 is formed with an inclined surface 79b inclined to the lower side toward the back side. The inclined surface 79b is disposed behind the inclined surface 79a, and an upper end of the inclined surface 79a and an upper end of the inclined surface 79b are connected. Note that the guide member 79 may be formed integrally with the accommodating portion 15.

In the embodiment described above, the cutting mechanism 7 may be disposed between the tension bar 9 and the second cutting mechanism 8 in the transport direction of the medium 2. The printing and cutting device 1 may not include the cutting mechanism 7. Furthermore, in the embodiment described above, the heater 6 may not be disposed between the printing mechanism 3 and the tension bar 9 in the transport direction of the medium 2. In the embodiment described above, the biasing member that biases the tension bar 9 may be a spring member other than the tension coil spring 46. In the embodiment described above, the first margin portion 2b between the to-be-cut portions 2a in the medium transport direction may not be formed. Furthermore, in the embodiment described above, the printing and cutting device 1 may be a printer other than the inkjet printer.

Furthermore, in the embodiment described above, the inclined surface 44e may not be formed in the medium pressing member 44, and the inclined surface 44h may not be formed. In the embodiment described above, the cutter blade 38 may be a double-edged blade. In this case, the medium 2 can be cut by the cutter blade 38 regardless of which side the carriage 34 moves to in the left-right direction. In this case, for example, first inclined surfaces corresponding to the inclined surfaces 44d are formed at both end portions in the left-right direction of the opposing surface 44a of the medium pressing member 44, and both sides in the left-right direction become the first direction side.

In the embodiment described above, the cutting mechanism 7 may not include the medium pressing member 44. In the embodiment described above, the printing and cutting device 1 may not include the second cutting mechanism 8. In this case, the cutting mechanism 7 cuts the medium 2 over the entire region in the width direction of the medium 2. In this case, for example, the printing and cutting device 1 may not include the medium winding unit 17 and the guide member 29. Furthermore, in the embodiment described above, the printing and cutting device 1 may not include the cutting mechanism 7 or may not include the printing mechanism 3.

### REFERENCE SIGNS LIST

1 Printing and cutting device (printing device, cutting device)
2 Medium
2a To-be-cut portion (first medium portion)
2b First margin portion (first medium portion)
2c Second margin portion (second medium portion)
3 Printing mechanism
5 Medium transporting mechanism
6 Heater
7 Cutting mechanism
8 Second cutting mechanism
9 Tension bar
10 Tension applying mechanism
15 Accommodating portion
20 Head (inkjet head)
21 Carriage
22 Carriage driving mechanism
26 Medium winding mechanism
29, 79 Guide member
30 Second medium transporting mechanism (medium transporting mechanism)
31 Cutting platen (cutting platen)
31a Opposing portion
31b Second opposing portion
34 Carriage
36 Carriage driving mechanism
38 Cutter blade
44 Medium pressing member
44a Opposing surface
44d Inclined surface (first inclined surface)
44e Inclined surface (third inclined surface)
44g Inclined surface forming portion
44h Inclined surface (second inclined surface)
46 Tension coil spring (biasing member)
47 Bar holding portion
48 First sensor
49 Second sensor
58 To-be-fixed member
59 Contact member
CL11 to CL14 Cut line
X2 Biasing direction side
Y Main scanning direction, width direction of medium

1. A printing device comprising: a printing mechanism that performs printing on a long medium; a medium transporting mechanism that transports the medium in a longitudinal direction of the medium; a cutting mechanism that cuts the medium after printing in a width direction of the medium orthogonal to a transport direction of the medium; and a tension applying mechanism that includes a tension bar that comes into contact with the medium after printing and applies tension to the medium; wherein
the medium transporting mechanism is disposed on an upstream side of the tension bar in a transport direction of the medium, and
the tension bar is disposed between the printing mechanism and the cutting mechanism in the transport direction of the medium.

2. The printing device as set forth in claim 1, comprising: a second medium transporting mechanism that transports the medium in a longitudinal direction of the medium, and a second cutting mechanism that cuts the medium after printing along a transport direction of the medium; wherein
the second medium transporting mechanism and the second cutting mechanism are disposed on a downstream side of the tension bar in a transport direction of the medium.

3. (canceled)

4. The printing device as set forth in claim 1, wherein
the tension applying mechanism includes a biasing member that biases the tension bar in a direction of pressing the tension bar against the medium, and a bar holding portion that movably holds the tension bar; and
the tension bar is movable with respect to the bar holding portion to a biasing direction side and a side opposite to the biasing direction side of the tension bar by the biasing member.

5. The printing device as set forth in claim 1, comprising:
a heater for heating the medium after printing; and
the heater is disposed between the printing mechanism and the tension bar in the transport direction of the medium.

6. The printing device as set forth in claim 1, wherein the printing mechanism includes an inkjet head that ejects ink onto the medium, a carriage on which the inkjet head is mounted, and a carriage driving mechanism that moves the carriage in a main scanning direction that is a width direction of the medium.

7. The printing device as set forth in claim 1, wherein the tension applying mechanism includes a biasing member that biases the tension bar in a direction of pressing the tension bar against the medium, a first sensor that detects a position of the tension bar on a biasing direction side by the biasing member, and a second sensor that detects a position of the tension bar on a side opposite to the biasing direction side.

8. A cutting device for cutting a long medium, the cutting device comprising:
a medium transporting mechanism configured to transport the medium in a longitudinal direction of the medium, a cutting mechanism configured to cut the medium in a width direction of the medium orthogonal to a transport direction of the medium, and a cutting platen having an opposing portion disposed facing the cutting mechanism; wherein
the cutting mechanism includes a cutter blade that cuts the medium, a carriage that holds the cutter blade, a carriage driving mechanism that moves the carriage in a width direction of the medium, and a medium pressing member that presses the medium toward the opposing portion,
the medium pressing member is attached to the carriage,
the medium pressing member is formed with an opposing surface facing the opposing portion,
assuming that an advancing direction side of the carriage when the cutter blade cuts the medium is a first direction side,
a first inclined surface is formed at an end portion on the first direction side of the opposing surface, the first inclined surface being inclined toward a side away from the opposing portion toward the first direction side, and
the first inclined surface is disposed on the first direction side than the cutter blade.

9. The cutting device as set forth in claim 8, comprising
a second cutting mechanism that cuts the medium along a transport direction of the medium,
the second cutting mechanism is disposed on an upstream side of the cutting mechanism in the transport direction of the medium, and
the cutting mechanism cuts a part of the medium so as to cross a portion of the medium cut by the second cutting mechanism, and cuts a part of the medium in a width direction of the medium.

10. The cutting device as set forth in claim 9, comprising: with a portion of the medium cut by the second cutting mechanism portion as a cut line, a portion of the medium disposed on one side in a width direction of the medium with the cut line as a boundary defined as a first medium portion, and a portion of the medium disposed on the other side in the width direction of the medium with the cut line as a boundary second medium portion, an accommodating portion in which the first medium portion is accommodated, and a medium winding mechanism that winds the second medium portion.

11. The cutting device as set forth in claim 10, wherein the accommodating portion is disposed on a lower side of the cutting mechanism and the second cutting mechanism.

12. The cutting device as set forth in claim 9, comprising a printing mechanism that performs printing on the medium, wherein
the printing mechanism is disposed on an upstream side of the second cutting mechanism in the transport direction of the medium.

13. The cutting device as set forth in claim 8, wherein
the medium pressing member includes an inclined surface forming portion in which the first inclined surface is formed, and
an end portion of the inclined surface forming portion on a downstream side in the transport direction of the medium is a second inclined surface inclined toward an upstream side in the transport direction of the medium toward the first direction side.

14. The cutting device as set forth in claim 8, wherein
when an opposite side of the first direction side is a second direction side,
a third inclined surface is formed at an end portion on the second direction side of the opposing surface, the third inclined surface being inclined toward a side away from the opposing portion toward the second direction side.

15. (canceled)

16. A cutting device for cutting a long medium, the cutting device comprising:
a medium transporting mechanism that transports the medium in a longitudinal direction of the medium, and a second cutting mechanism that cuts the medium along a transport direction of the medium; and
wherein when a portion of the medium cut by the second cutting mechanism is defined as a cut line, a portion of the medium disposed on one side in a width direction of the medium orthogonal to a transport direction of the medium with the cut line as a boundary is defined as a first medium portion, and a portion of the medium disposed on the other side in the width direction of the medium with the cut line as a boundary is defined as a second medium portion,
the cutting device includes an accommodating portion in which the first medium portion is accommodated; a medium winding mechanism that winds the second medium portion; and a guide member that is disposed between the accommodating portion and the second cutting mechanism in a transport direction of the medium and guides the first medium portion in a direction away from the second medium portion.

17. The cutting device as set forth in claim 16, comprising a cutting mechanism that cuts the medium in a width direction of the medium, wherein
the cutting mechanism is disposed between the second cutting mechanism and the guide member in the transport direction of the medium.

18. The cutting device as set forth in claim 17, comprising:
a cutting platen having an opposing portion disposed facing the cutting mechanism, wherein
the cutting mechanism includes a cutter blade that cuts the medium, a carriage that holds the cutter blade, a carriage driving mechanism that moves the carriage in a width direction of the medium, and a medium pressing member that presses the medium toward the opposing portion,
the medium pressing member is attached to the carriage,
the medium pressing member is formed with an opposing surface facing the opposing portion, and
assuming that an advancing direction side of the carriage when the cutter blade cuts the medium is a first direction side,
a first inclined surface is formed at an end portion on the first direction side of the opposing surface, the first inclined surface being inclined toward a side away from the opposing portion toward the first direction side, and
the first inclined surface is disposed closer to the first direction side than the cutter blade.

19. The cutting device as set forth in claim 16, comprising a printing mechanism that performs printing on the medium, wherein
the printing mechanism is disposed on an upstream side of the second cutting mechanism in the transport direction of the medium.

20. The cutting device as set forth in claim 16, comprising a cutting platen having a second opposing portion disposed facing the second cutting mechanism, wherein
the guide member is attached to the cutting platen.

21. The cutting device as set forth in claim 20, wherein
the guide member includes a to-be-fixed member fixed to the cutting platen and a contact member that comes into contact with the first medium portion,
the contact member is attached to the to-be-fixed member, and
an attachment position of the contact member with respect to the to-be-fixed member in a thickness direction of the medium is adjustable.

22. The cutting device as set forth in claim 16, wherein the guide member is attached to the accommodating portion or formed integrally with the accommodating portion.
